(19) United States
(12) Patent Application Publication
(10) Pub. No.: US 2026/0333035 A1
(43) Pub. Date: Oct. 22, 2026

(54) RADIO ACCESS NETWORK (RAN) AUTHENTICATION

(71) Applicant: Lenovo (United States) Inc., Morrisville, NC (US)

(72) Inventors: Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 19/285,580

(22) Filed: Jul. 30, 2025

(51) Int. Cl. H04W 12/06; H04W 12/106; H04W 76/10

(52) U.S. Cl. CPC H04W 12/06; H04W 12/106; H04W 76/10

(57) ABSTRACT

Various aspects of the present disclosure relate to radio access network (RAN) authentication. System information and protection information for a radio access network (RAN) node are received. Based at least in part on a digital signature of the radio protection information or a message authentication code for integrity (MAC-I) of the radio protection information, an authenticity of the RAN node is verified.

### TECHNICAL FIELD

The present disclosure relates to wireless communications, and more specifically to radio access network (RAN) authentication.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive system information and protection information for a RAN node; and verify, based at least in part on a digital signature of the protection information or a message authentication code for integrity (MAC-I) of the protection information, an authenticity of the RAN node.

A processor (e.g., a standalone processor chipset, or a component of a UE) for wireless communication is described. The processor may be configured to, capable of, or operable to perform one or more operations as described herein. For example, the processor may be configured to, capable of, or operable to receive system information and protection information for a RAN node; and verify, based at least in part on a digital signature of the protection information or a MAC-I of the protection information, an authenticity of the RAN node.

A method performed or performable by a UE for wireless communication is described. The method may include receiving system information and protection information for a RAN node; and verifying, based at least in part on a digital signature of the protection information or a MAC-I of the protection information, an authenticity of the RAN node.

In some implementations of the UE, processor, and method described herein, the UE, processor, and method may further be configured to, capable of, performed, performable, or operable to receive a set of authorized RAN node identifiers (IDs), serving area and cell identifier (ID) information, and RAN data protection or security information.

In some implementations of the UE, processor, and method described herein, the UE, processor, and method, to receive the system information, may further be configured to, capable of, performed, performable, or operable to receive a master information block (MIB), and to verify the authenticity of the RAN node, the UE, processor, and method may further be configured to, capable of, performed, performable, or operable to verify the authenticity of the RAN node based at least in part on one or more of a set of authorized RAN node IDs, a set of cell IDs, or the protection information.

In some implementations of the UE, processor, and method described herein, to receive the system information, the UE, processor, and method, may further be configured to, capable of, performed, performable, or operable to receive a system information block type 1 (SIB1), and to verify the authenticity of the RAN node, the UE, processor, and method may further be configured to, capable of, performed, performable, or operable to verify the authenticity of the RAN node based at least in part on one or more of a set of authorized RAN node IDs, a set of cell IDs, or the protection information.

In some implementations of the UE, the processor, and the method described herein, the protection information comprises an identifier of a protection algorithm.

In some implementations of the UE, processor, and method described herein, the UE, processor, and method may further be configured to, capable of, performed, performable, or operable to receive information including an ID associated with the RAN node, and a parameter, where the ID comprises one or more of a RAN node ID, a cell ID, or a public key ID, where the parameter indicates how recent or up-to-date the information is, where to receive the system information, the UE, processor, and method may further be configured to, capable of, performed, performable, or operable to receive a radio resource control (RRC) setup message, and where to verify the authenticity of the RAN node, the at least one processor is operable to cause the UE to verify the authenticity of the RAN node based at least in part on the public key ID and the protection algorithm.

In some implementations of the UE, the processor, and the method described herein, the digital signature comprises a digital signature of one or more of: an information block, the RRC setup message, the protection information, the RAN node ID, the cell ID, the public key ID, or the parameter.

In some implementations of the UE, processor, and method described herein, to receive the system information, the UE, processor, and method, may further be configured to, capable of, performed, performable, or operable to receive a RRC setup message.

A UE for wireless communication is described. The UE may be configured to, capable of, or operable to perform one or more operations as described herein. For example, the UE may be configured to, capable of, or operable to receive protection information for a RAN node; transmit a protection verification information request that includes a RAN or cell ID for the RAN node; receive a protection verification information response that includes security credentials for the RAN node; verify, based at least in part on the protection information for the RAN node and the security credentials for the RAN node, an authenticity of the RAN node.

A processor (e.g., a standalone processor chipset, or a component of a UE) for wireless communication is described. The processor may be configured to, capable of, or operable to perform one or more operations as described herein. For example, the processor may be configured to, capable of, or operable to receive protection information for a RAN node; transmit a protection verification information request that includes a RAN or cell ID for the RAN node; receive a protection verification information response that includes security credentials for the RAN node; verify, based at least in part on the protection information for the RAN node and the security credentials for the RAN node, an authenticity of the RAN node.

A method performed or performable by a UE for wireless communication is described. The method may include receiving protection information for a RAN node; transmitting a protection verification information request that includes a RAN or cell ID for the RAN node; receiving a protection verification information response that includes security credentials for the RAN node; verifying, based at least in part on the protection information for the RAN node and the security credentials for the RAN node, an authenticity of the RAN node.

In some implementations of the UE, the processor, and the method described herein, the protection information comprises an identifier of an information protection algorithm.

In some implementations of the UE, the processor, and the method described herein, the security credentials for the RAN node comprise at least one of a latest public key of the RAN node, a latest valid certificate of the RAN node, a root certificate authority (CA) certificate of an issuer of the latest valid certificate of the RAN node, one or more selected protection algorithms and related algorithm IDs, a selected protection type indicator, or a validity or lifetime of the latest public key of the RAN.

In some implementations of the UE, the processor, and the method described herein, to verify the authenticity of the RAN node, the UE, processor, and method, may further be configured to, capable of, performed, performable, or operable to verify the authenticity of the RAN node based at least in part on a digital signature of the protection information or a MAC-I of the protection information.

In some implementations of the UE, processor, and method described herein, the UE, processor, and method may further be configured to, capable of, performed, performable, or operable to verify the authenticity of the RAN node based at least in part on one or more of a list of authorized RAN IDs, cell IDs, or protection information.

In some implementations of the UE, the processor, and the method described herein, to transmit the protection verification information request, the UE, processor, and method, may further be configured to, capable of, performed, performable, or operable to transmit the protection verification request to a verification service, and where to receive the protection verification information response, the at least one processor is operable to cause the UE to receive the protection verification information response from the verification service.

An NE (e.g., a base station) for wireless communication is described. The NE may be configured to, capable of, or operable to perform one or more operations as described herein. For example, the NE may be configured to, capable of, or operable to transmit system information and protection information for a RAN node.

A processor (e.g., a standalone processor chipset, or a component of an NE (e.g., a base station)) for wireless communication is described. The processor may be configured to, capable of, or operable to perform one or more operations as described herein. For example, the processor may be configured to, capable of, or operable to transmit system information and protection information for a RAN node.

A method performed or performable by an NE (e.g., a base station) for wireless communication is described. The method may include transmitting system information and protection information for a RAN node.

In some implementations of the NE, the processor, and the method described herein, the NE is provisioned with an authorized RAN node ID, serving area and cell ID information, and RAN data protection or security information.

In some implementations of the NE, the processor, and the method described herein, the protection information comprises an identifier of a protection algorithm.

In some implementations of the NE, processor, and method described herein, the NE, processor, and method may further be configured to, capable of, performed, performable, or operable to cause the NE to transmit information including a RAN or cell ID for the RAN node, a public key ID for the RAN node, and a parameter that indicates how recent or up-to-date the information is.

An NE (e.g., a base station) for wireless communication is described. The NE may be configured to, capable of, or operable to perform one or more operations as described herein. For example, the NE may be configured to, capable of, or operable to transmit protection information for a RAN node; receive a protection verification information request that includes a RAN or cell ID for the RAN node; transmit a radio protection verification information response that includes security credentials for the RAN node.

A processor (e.g., a standalone processor chipset, or a component of an NE (e.g., a base station)) for wireless communication is described. The processor may be configured to, capable of, or operable to perform one or more operations as described herein. For example, the processor may be configured to, capable of, or operable to transmit protection information for a RAN node; receive a protection verification information request that includes a RAN or cell ID for the RAN node; transmit a radio protection verification information response that includes security credentials for the RAN node.

A method performed or performable by an NE (e.g., a base station) for wireless communication is described. The method may include transmitting protection information for a RAN node; receiving a protection verification information request that includes a RAN or cell ID for the RAN node; transmitting a radio protection verification information response that includes security credentials for the RAN node.

In some implementations of the NE, the processor, and the method described herein, the security credentials for the RAN node comprise at least one of a latest public key of the RAN node, a latest valid certificate of the RAN node, a root certificate authority (CA) certificate of an issuer of the latest valid certificate of the RAN node, one or more selected protection algorithms and related algorithm IDs, a selected protection type indicator, or a validity or lifetime of the latest public key of the RAN.

### BRIEF DESCRIPTION OF THE DRAWINGS

FIG. 1 illustrates an example of a wireless communications system in accordance with aspects of the present disclosure.

FIG. 2 illustrates an example of RAN authentication in accordance with aspects of the present disclosure.

FIG. 3 illustrates an example of base station authentication verification during system information acquisition in accordance with aspects of the present disclosure.

FIG. 4 illustrates an example of base station authentication verification during RRC connection establishment in accordance with aspects of the present disclosure.

FIG. 5 illustrates an example of base station authentication verification during RRC connection establishment in accordance with aspects of the present disclosure.

FIG. 6 illustrates an example of base station authentication verification during system information provisioning in accordance with aspects of the present disclosure.

FIG. 7 illustrates an example of base station authentication verification using a distributed ledger technology (DLT) in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of an NE in accordance with aspects of the present disclosure.

FIGS. 11 and 12 illustrate flowcharts methods performed by a UE in accordance with aspects of the present disclosure.

FIGS. 13 and 14 illustrate flowcharts of methods performed by an NE in accordance with aspects of the present disclosure.

### DETAILED DESCRIPTION

In some wireless communications system, a UE connects to a core network via a RAN, such as via a base station. The UE, however, may lack the mechanism to determine (e.g., identify, verify) whether the base station is an authorized (e.g., genuine, authentic) base station in the wireless communication system. In some cases, this vulnerability can be exploited by an unauthorized base station (e.g., rogue base station) that may transmit one or more messages including inaccurate information to the UE, for example false MIBs, false SIBs, and so forth, leading to service failure.

Some wireless communication systems support various security mechanisms, with a primary focus on protecting communications after a connection has been established. As a result, a UE may interact with a base station without verifying whether the base station is an authorize base station (e.g., genuine, authentic). This vulnerability can be exploited by an unauthorized base station to carry out various malicious activities, including false base station attacks, which may result in both active and passive security impacts. Such attacks therefore represent a persistent security concern for wireless communications systems.

Various aspects of the present disclosure enable secure wireless communications, and more particularly authentication of a network entity (e.g., prior to or during establishment of connectivity with the network entity). In a wireless communication system, a UE may subscribe to a service of a network operator. The network operator may deploy a mechanism, such as an authentication mechanism that enables the UE to verify (e.g., authenticate) whether a base station operating in the wireless communication system is an authorized base station (e.g., genuine, authentic). The network operator may provide a set of one or more security parameters to the UE to perform the verification of the base station. When the UE (e.g., a mobile phone) is powered ON, the UE may verify the base station and, in response to determining that the base station is authorized, camp on the base station. The UE may then initiate a registration procedure for a corresponding radio access technology (e.g., 6G or beyond) of the wireless communications system. By applying these techniques, the UE consistently camps on and accesses services from authorized base stations associated with the UE's subscribed network operator.

Accordingly, using the techniques discussed herein, a UE is able to distinguish a false base station from an authentic base station, increasing the level of security between the radio network entities and the UE during the initial network selection procedure and thus preventing false base stations from being connected to at earlier stages of communication establishment. The sooner that security threats are addressed in the process of interaction between components of the system, the more risks can be reduced to the wireless communications system.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

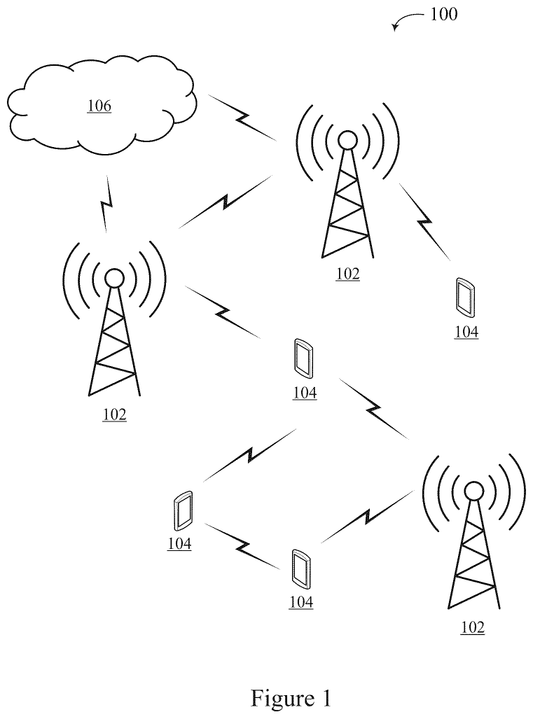

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR 2 may be associated with a third numerology (e.g., μ=2), which includes 60 kHz subcarrier spacing; and a fourth numerology (e.g., μ=3), which includes 120 kHz subcarrier spacing.

With respect to UE-assisted network-based detection of a false base station, the UE in RRC_CONNECTED mode sends measurement reports to the network in accordance with the measurement configuration provided by the network. These measurement reports have security values in being useful for detection of false base stations or SUPI/5G-GUTI catchers. The network, in an implementation specific way, could choose UEs or tracking areas or duration for which the measurement reports are to be analyzed for detection of a false base station. The following gives examples of how measurement reports from UEs could be used for detection of a false base station, and some actions thereafter.

The received-signal strength and location information in measurement reports can be used to detect a false base station which attract the UEs by transmitting signal with higher power. They can also be used to detect a false base station which replays the genuine MIB/SIB without modification.

In order to detect a false base station that replays a modified version of broadcast information to prevent victim UEs from switching back and forth between itself and a genuine base station (e.g., modifying neighboring cells, cell reselection criteria, registration timers, etc. to avoid the so called ping-pong effect), information on broadcast information can be used to detect inconsistency from the deployment information.

Further, a false base station that uses inconsistent cell identifier or operates in inconsistent frequency than the deployment of the genuine base stations can be detected respectively by using the cell identifier or the frequency information in the measurement reports. Measurement reports collected from multiple UEs can be used to filter out incorrect reports sent by a potential rogue UE.

Upon detection of the false base station, the operator can take further actions, e.g., informing legal authorities or contacting the victim UE.

One drawback to this approach is this approach allows false base station identification only in later stages of UE connection such as UE RRC_CONNECTED state. This approach does not allow identification of whether the base station is a legitimate base station or a fake base station during the initial stages of UE access stratum (AS) connection attempts. Accordingly, this solution cannot solve the problem listed in the problem statement.

The NEs 102 and the UEs 104 implement authenticity verification mechanisms such that a UE 104 can verify the authenticity of the base station. When a user activates (e.g., turns on) the UE 104, the UE 104 verifies the authenticity of the NE 102. The UE camps on the verified NE 102 and proceeds with the registration procedure for the radio access technology (e.g., 6G or beyond) of the wireless communications system 100.

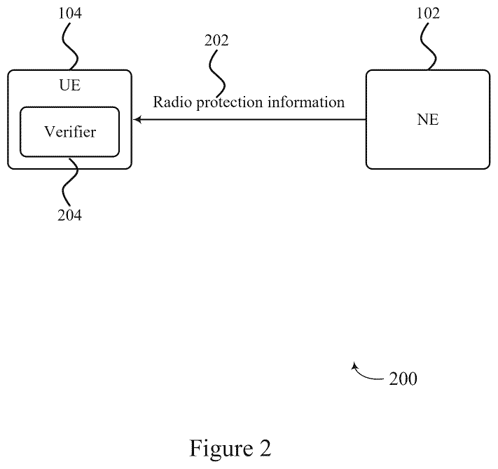

FIG. 2 illustrates an example 200 of RAN authentication in accordance with aspects of the present disclosure. The NE 102 communicates (e.g., transmits, sends, signals, or the like) radio protection information 202 to the UE 104. The NE 102 may also communicate (e.g., transmit, send, signal, or the like) additional information, such as one or more of a RAN or cell identifier ID for the RAN, a public key ID for the RAN, or a freshness parameter. The UE 104 communicates (e.g., transmits, sends, signals, or the like) the information from the NE 102 and a verifier 204 uses the information to verify the authenticity of the NE 102 (e.g., the RAN). The NE 102 can communicate (e.g., transmit, send, signal, or the like) the radio protection information 202 and optionally additional information via one or more of a MIB, a SIB1, or RRC setup information.

In one or more implementations, the UE 104 is provisioned with a list or set of legitimate, genuine, or authorized base stations, along with serving area information and/or cell ID(s) and related security information. The related security information can be one or more of a RAN public key, radio information protection algorithms and related algorithm IDs, and so forth, which can also be considered as a list of RAN security capabilities information. During RAN initial access, the UE 104 uses the RAN public key of the base station (e.g., NE 102) to verify the signed radio information provided by the base station (e.g., NE 102). Alternatively, or additionally, the UE 104 uses the pre-provisioned RAN verification key related to the base station (e.g., NE 102), such as a shared secret key or a subscriber public/private key pair which can be used by the UE 104 to derive a shared secret key, and verifies the MAC-I for messages received from the base station (e.g., NE 102).

From the UE 104 to the base station (e.g., NE 102), the UE 104 generates a shared secret key using the RAN public key and ephemeral public/private key pair and encrypts and integrity protects the radio messages towards the base station (e.g., NE 102), such as by using elliptic curve integrated encryption scheme (ECIES) generates concealed RAN information and MAC tag using the shared secret key.

Alternatively, or additionally, the UE 104 verifies the base station (e.g., NE 102) provided signed RRC set up using the RAN public key and other RAN/Radio protection information during RRC Connection establishment. Alternatively, or additionally, the UE 104 verifies the base station (e.g., NE 102) provided signed system information using the RAN public key and other RAN/radio protection information during a System Information Provision process.

Alternatively, or additionally, the UE 104 is provisioned with a list or set of legitimate, genuine, or authorized base stations, along with serving area information and/or cell ID(s) and related security information. Alternatively, or additionally, the RAN or base station (e.g., NE 102) certificate with public key and RAN security capabilities are stored in a blockchain/permissioned distributed ledger (PDL) repository whose blockchain address is provisioned in the UE 104.

Returning to FIG. 1, in one or more implementations, a technique to identify an authentic base station during system information acquisition and protect the system information is described. This technique describes how the UE 104 can check whether a base station is authentic, genuine, or authorized before using the system information provided by the base station while connecting to the RAN (e.g., a 6G network) via the base station. This technique describes different ways to verify the base station authenticity as follows: using a base station public key based digital signature verification method, or a shared secret key based base station provided radio information MAC-I verification method.

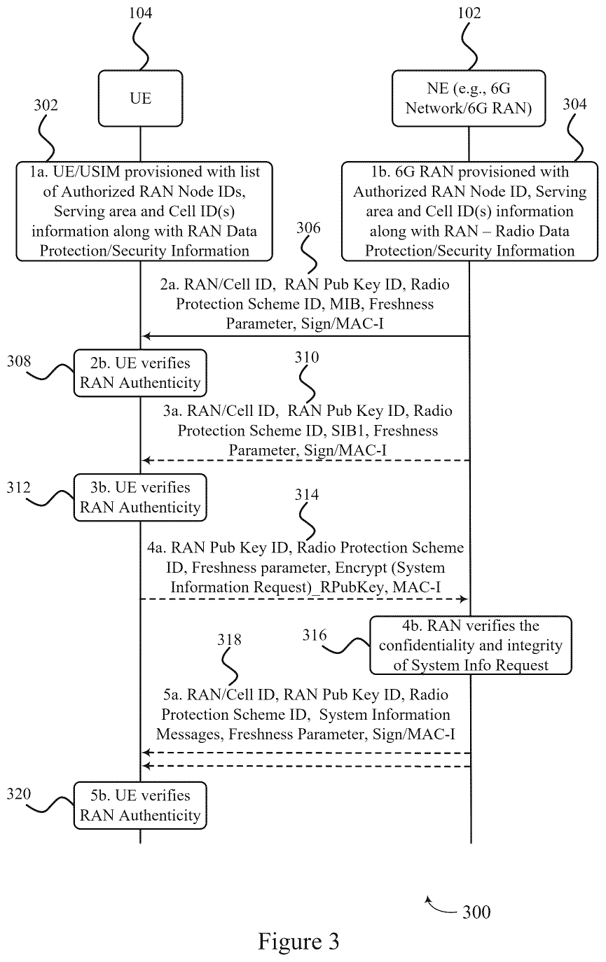

FIG. 3 illustrates an example 300 of base station authentication verification during system information acquisition in accordance with aspects of the present disclosure. The example 300 is an example of a base station public key based digital signature verification method. The example 300 illustrates a UE 104 and an NE 102 (e.g., a base station, a device of a 6G network or 6G RAN).

At 302, with respect to RAN verification or radio access data protection/security information at the UE 104, the radio data protection/security information includes one or more of the following: protection schemes (e.g., such as ECIES, or post-quantum cryptography (PQC) algorithms for signatures such as Crystals-Dilithium, FALCON, SPHINCS+) along with radio protection scheme identifier, serving RAN public key or certificate, serving RAN public key ID (e.g., an identifier used to indicate which public/private key pair is used for MIB/SIB/radio system information protection). A protection can be a concealment/de-concealment, or signing and sign verification.

The UE/universal subscriber identity module (USIM) is provisioned with a list or set of authorized RAN node IDs, and serving area and cell ID(s) information along with RAN data protection/security information (also referred to as radio data protection). The UE/USIM is provisioned with the following information by the mobile network operator (e.g., the home network or serving network) to perform RAN verification or radio access data protection/security at the UE side. The information includes a list, set, or identification of authorized RAN node/base station identifier(s) (e.g., 6G network cell ID (6G-NCI), which may consist of a base station ID (BS ID, e.g., 6G gNB ID/6G Node ID) and cell ID) along with the information specific to the RAN node/base station, such as one or more of related cell identifiers, specific serving area information, RAN security information, radio security capabilities, or radio data protection type indicator. The related cell identifier refers to, for example, a physical cell ID (PCI), a general cell ID, or the like. A specific serving area information refers to, for example, a tracking area code (TAC), a tracking area identity (TAI) and a cell global identity (e.g., public land mobile network (PLMN) ID/NPN-ID and 6G-NCI), or the like. The RAN security information refers to, for example, a RAN public key/certificate along with the RAN public key ID. In the case of a certificate, the root CA certificate is also provided for RAN Certificate verification.

The radio security capabilities refers to one or more radio information protection algorithms and related algorithm IDs, such as a National Institute of Standards and Technology (NIST) PQC algorithm, an NIST PQC Key encapsulation mechanism, an NIST PQC public-key encryption algorithm, a symmetric encryption algorithm, or ECIES. The NIST PQC algorithm for signatures can include at least one of the following and the related signature scheme IDs: Cystals-Dilithium/module-lattice-based digital signature algorithm (ML-DSA), fast Fourier lattice-based compact signatures over Nth degree truncated polynomial ring (FALCON), or SPHINCS+/stateless hash-based digital signature algorithm (SLH-DSA). The NIST PQC Key encapsulation mechanisms can include mechanisms to establish shared secret key between the UE and the RAN over a public channel and the related algorithm/protection scheme ID(s). ML-KEM can be offered in any one or more of multiple (e.g., three) parameters sets, such as ML-KEM-512, ML-KEM-768, or ML-KEM-1024. The NIST PQC public-key encryption algorithm, e.g., as backup to ML-KEM, and its related algorithm Identifier(s) can include, for example, Hamming Quasi-Cyclic (HQC). The symmetric encryption algorithm and related algorithm IDs can include, for example, one or more of advanced encryption standard (AES), ZUC, or SNOW-3G.

The radio data protection type indicator refers to, for example, need digital signature verification only, need encryption for confidentiality protection only, need MAC-I verification for integrity protection only, both confidentiality protection and integrity protection needed, or the like. The need digital signature verification only refers to, for example, an authentication check (e.g., by means of public/private key pairs). The need encryption for confidentiality protection only refers to, for example, shared secret generation using a key encapsulation protocol (e.g., ML-KEM) and then using a symmetric algorithm to encrypt the message (e.g., AES), or, using a public key to encrypt the message (e.g., HQC), or using the public key of the receiver, generating a shared secret by generating a sender's ephemeral public/private key pair compute encryption and MAC-Tag (e.g., using ECIES). The need MAC-I verification for integrity protection only refers to, for example, shared secret generation using a key encapsulation protocol (e.g., ML-KEM) and then using a symmetric algorithm to generate the MAC-I of the message (e.g., AES/ZUC/SNOW-3G), or, using the public key of the receiver, generating a shared secret by generating a sender's ephemeral public/private key pair compute encryption and MAC-Tag (e.g., using ECIES).

At 304, with respect to RAN verification or radio access data protection/security information at the NE 102 (e.g., a 6G network/6G RAN), the radio data protection/security Information includes one or more of the following: protection schemes (e.g., such as ECIES, or PQC algorithms for signatures such as Crystals-Dilithium, FALCON, SPHINCS+) along with radio protection scheme identifier, serving RAN public/private key pair(s), serving RAN public key ID(s) (e.g., an identifier used to indicate the public/private key pair used for MIB/SIB/radio system information protection). A protection can be a concealment/de-concealment, or signing and sign verification. In one or more implementations the algorithm used for radio data protection is executed in the secure environment of the RAN Node.

The RAN/base station is provisioned with an authorized RAN node ID, serving area and cell ID(s) information along with RAN—radio data protection/security information. The NE (e.g., RAN node or base statin) is provisioned with the following information by the mobile network operator (e.g., the home network or serving network) to perform RAN verification or radio access data protection/Security. The information includes an authorized RAN node/base station identifier (e.g., 6G-NCI, which may consist of a BS ID (e.g., 6G gNB ID/ 6G Node ID) and cell ID(s) along with information specific to the RAN node/base station, such as one or more of related cell identifiers, specific serving area information, RAN security information, radio security capabilities, or radio data protection type indicator. The related cell identifier refers to, for example, a PCI, a general cell ID, or the like. A specific serving area information refers to, for example, a TAC, a TAI and a cell global identity (e.g., PLMN ID/NPN-ID and 6G-NCI), or the like. The RAN security information refers to, for example, a RAN public/private key pair with RAN public key ID/public key certificate and private key along with the RAN public key ID.

The radio security capabilities refers to one or more radio information protection algorithms and related algorithm IDs, such as an NIST PQC algorithm, an NIST PQC Key encapsulation mechanism, an NIST PQC public-key encryption algorithm, a symmetric encryption algorithm, or an ECIES. The NIST PQC algorithm for signatures can include at least one of the following and the related signature scheme IDs: Cystals-Dilithium/ML-DSA, FALCON, or SPHINCS+/SLH-DSA. The NIST PQC Key encapsulation mechanisms can include mechanisms to establish shared secret key between the UE and the RAN over a public channel and the related algorithm/protection scheme ID(s). ML-KEM can be offered in any one or more of multiple (e.g., three) parameters sets, such as ML-KEM-512, ML-KEM-768, or ML-KEM-1024. The NIST PQC public-key encryption algorithm, e.g., as backup to ML-KEM, and its related algorithm Identifier(s) can include, for example, HQC. The symmetric encryption algorithm and related algorithm IDs can include, for example, one or more of AES, ZUC, or SNOW-3G.

The radio data protection type indicator refers to, for example, need digital signature verification only, need encryption for confidentiality protection only, need MAC-I verification for integrity protection only, both confidentiality protection and integrity protection needed, or the like. At least one of these values is set based on the operator local policy. The need digital signature verification only refers to, for example, an authentication check (e.g., by means of public/private key pairs). The need encryption for confidentiality protection only refers to, for example, shared secret generation using a key encapsulation protocol (e.g., ML-KEM) and then using a symmetric algorithm to encrypt the message (e.g., AES), or, using a public key to encrypt the message (e.g., HQC), or using the public key of the receiver, generating a shared secret by generating a sender's ephemeral public/private key pair compute encryption and MAC-Tag (e.g., using ECIES). The need MAC-I verification for integrity protection only refers to, for example, shared secret generation using a key encapsulation protocol (e.g., ML-KEM) and then using a symmetric algorithm to generate the MAC-I of the message (e.g., AES/ZUC/SNOW-3G), or, using the public key of the receiver, generating a shared secret by generating a sender's ephemeral public/private key pair compute encryption and MAC-Tag (e.g., using ECIES).

During RAN initial access, the UE 104 uses the RAN Public key of the base station (e.g., the NE 102) to verify the signed radio information provided by the base station.

At 306, the NE 102 communicates (e.g., transmits, sends, signals, or the like) one or more of the RAN/cell ID, RAN public key ID, radio data protection type indication (indicating digital signature), radio protection algorithm (e.g., scheme) ID(s), MIB, or a parameter (e.g., that indicates how recent or up-to-date the communication or the information being communicated is) and their digital signature generated using the RAN private key to protect the integrity of the MIB and for RAN authenticity.

The parameter (also referred to as a freshness parameter) that indicates how recent or up-to-date the communication or the information being communicated is can be any one or more of a timestamp, a count (e.g., related to radio signaling connection), a random number, or a nonce value. It should be noted that all information elements (IEs) at 306 can be individual IEs or ones of the IEs can be grouped together, e.g., as MIB, MIB security information and sign/MAC-I.

At 308, the UE 104 verifies the digital signature (of the RAN/cell ID, RAN public key ID, radio data protection type indication (indicating digital signature), radio protection algorithm ID(s), MIB, or a parameter (e.g., that indicates how recent or up-to-date the communication or the information being communicated is)) based on the RAN verification or radio access data protection/security information available in the UE 104 (e.g., the digital signature is verified using the RAN public key identified with the RAN public key ID and using the radio protection algorithm indicated by the radio protection algorithm ID). If the digital signature verification is successful, the UE 104 considers the RAN as the authenticated/genuine/authorized RAN to provide the MIB to the UE 104, therefore the UE 104 uses the received MIB.

The digital signature verification process involves the UE 104 using the RAN public key to decrypt the signature and then comparing the resulting hash value with a hash value calculated from the original message. If the hash values match, the signature is valid, hence the UE 104 confirms both the sender's identity, e.g., RAN/cell ID and the MIB message's integrity. In one or more implementations, if the digital signature verification is failure the UE 104 sends a RAN authentication failure or a related error message to the NE 102.

At 310, the NE 102 communicates (e.g., transmits, sends, signals, or the like) one or more of the RAN/cell ID, RAN public key ID, radio data protection type indication (indicating digital signature), radio protection algorithm (e.g., scheme) ID(s), SIB1, or a parameter (e.g., that indicates how recent or up-to-date the communication or the information being communicated is) and their digital signature generated using the RAN private key to protect the integrity of the SIB1 and for RAN authenticity.

It should be noted that all IEs at 310 can be individual IEs or ones of the IEs can be grouped together, e.g., as SIB1, SIB1 security information and Sign/MAC-I.

At 312, the UE 104 verifies the digital signature (of the RAN/cell ID, RAN public Key ID, radio data protection type indication (indicating digital signature), radio protection algorithm ID(s), SIB1, or a parameter (e.g., that indicates how recent or up-to-date the communication or the information being communicated is)) based on the RAN verification or radio access data protection/security information available in the UE 104 (e.g., the digital signature is verified using the RAN public key identified with the RAN public key ID and using the radio protection algorithm indicated by the radio protection algorithm ID). If the digital signature verification is successful, the UE 104 considers the RAN as the authenticated/genuine/authorized RAN to provide the SIB1 to the UE 104, therefore the UE uses the received SIB1. In one or more implementations, if the digital signature verification is failure the UE 104 send a RAN authentication failure or a related error message to the NE 102.

At 314, the UE 104 at any time can communicate (e.g., transmit, send, signal, or the like) the system information request encrypted using the RAN public key and the indicated radio protection scheme/algorithm ID specific to the RAN/cell ID and generate the MAC-I of the encrypted system information request together with RAN public key ID, radio protection scheme/algorithm ID, and a parameter (e.g., that indicates how recent or up-to-date the communication or the information being communicated is). Further, the UE 104 communicates (e.g., transmits, sends, signals, or the like) one or more of the RAN public key ID, radio protection scheme/algorithm ID, a parameter (e.g., that indicates how recent or up-to-date the communication or the information being communicated is), encrypted system information request and the optionally MAC-I to the NE 102 (if MAC-I is generated then MAC-I is sent).

Alternatively, or additionally, if a shared secret key is used in encryption of system information request, the public key of the UE 104 used in the shared secret generation is also communicated (e.g., transmitted, sent, signaled, or the like) along with other information at 314 to the NE 102, so that the NE 102 can also generate the shared secret used for system information request decryption, MAC-I generation and verification.

If MAC-I is sent by the UE 104 to the NE 102, the public key of the UE 104 used in the shared secret generation is communicated (e.g., transmitted, sent, signaled, or the like) along with other information at 314 to the NE 102, so that the NE 102 can also generate the shared secret used for MAC-I generation and verification.

Alternatively, or additionally, at 314 the UE 104 instead of using Rpub_Key for encryption can use a pre-provisioned or generated shared secret key to perform encryption and related MAC-I generation. Alternatively, or additionally, the system information request at 314 can be communicated (e.g., transmitted, sent, signaled, or the like) in plaintext.

It should be noted that all IEs at 314 can be individual IEs or ones of the IEs can be grouped together, e.g., as system information request, security information and sign/MAC-I. If a digital signature is applied for a message at 314, then the UE 104 uses its private key/pre-provisioned subscriber/subscriber group private key to sign the message. In such a case, the NE 102 at 316 can use the pre-provisioned subscriber/subscriber group public key to verify the signature of the message at 314.

At 316, the NE 102 based on the RAN public key ID, uses the related RAN private key to decrypt the encrypted system information request.

Alternatively, or additionally, if the NE 102 additionally receives a UE public key, the RAN generates the shared secret key (or uses a pre-provisioned shared secret key) and performs decryption of system Information Request and MAC-I verification using the received information such as RAN public key ID, radio protection scheme/algorithm ID, a parameter (e.g., that indicates how recent or up-to-date the communication or the information being communicated is) and UE public key respectively.

In one or more implementations, if the message at 314 is plaintext, then the NE 102 proceeds directly to 318 (e.g., the verification at 316 is not applicable in this case).

At 318, the NE 102 communicates (e.g., transmits, sends, signals, or the like) one or more of the RAN/cell ID, RAN public key ID, radio data protection type indication (indicating digital signature), radio protection algorithm ID(s), system information messages, or a parameter (e.g., that indicates how recent or up-to-date the communication or the information being communicated is) and their digital signature generated using the RAN private key to protect the integrity of the MIB and for RAN authenticity. It should be noted that all IEs at 318 can be individual IEs or ones of the IEs can be grouped together, e.g., as system information request, security information and Sign/MAC-I.

At 320, the UE 104 verifies the digital signature (of the RAN/cell ID, RAN public key ID, radio data protection type indication (indicating digital signature), radio protection algorithm ID(s), system information messages, or a parameter (e.g., that indicates how recent or up-to-date the communication or the information being communicated is)) based on the RAN verification, or radio access data protection/security information available in the UE 104 (e.g., the digital signature is verified using the RAN public key identified with the RAN public key ID and using the radio protection algorithm indicated by the radio protection algorithm ID). If the digital signature verification is successful, the UE 104 considers the RAN as the authenticated/genuine/authorized RAN to provide the system information messages to the UE 104, therefore the UE 104 uses the received system information messages. In one or more implementations, if the digital signature verification is failure the UE 104 can send a RAN authentication failure or a related error message to the NE 102.

In one or more implementations, the example 300 uses a shared secret key based base station (e.g., NE 102) provided radio information MAC-I verification method. In such implementations, the example 300 applies with the following adaptations. At 306, 310, and 318, the NE 102 sends a MAC-I of at least part of the message (e.g., the entire message) instead of a digital signature, where the MAC-I is generated using a shared secret key derived by the NE 102 (e.g., a shared secret key provided for a specific RAN/cell ID, or deriving a shared secret key from the public/private key pair of the NE 102 and using a pre-provisioned subscriber/subscriber group public key). At 308, 312, and 320, if the UE 104 receives a MAC-I, the UE 104 uses the pre-provisioned RAN verification key related to the NE 102 (e.g., a shared secret key or a subscriber public/private key pair which can be used by the UE 104 together with the RAN's public key to derive a shared secret key) and verifies the MAC-I for messages received from the NE 102.

Returning to FIG. 1, in one or more implementations, a technique to identify an authentic base station during RRC connection establishment and protect the RRC connection establishment is described. This technique describes how the UE 104 can check whether a base station is authentic, genuine, or authorized before using the RRC set up message/information provided by the base station while connecting to the RAN (e.g., a 6G network) via the base station. This technique describes different ways to verify the base station authenticity during the RRC connection establishment procedure as follows: using a base station public key based digital signature verification method, or a shared secret key based base station provided radio information MAC-I verification method.

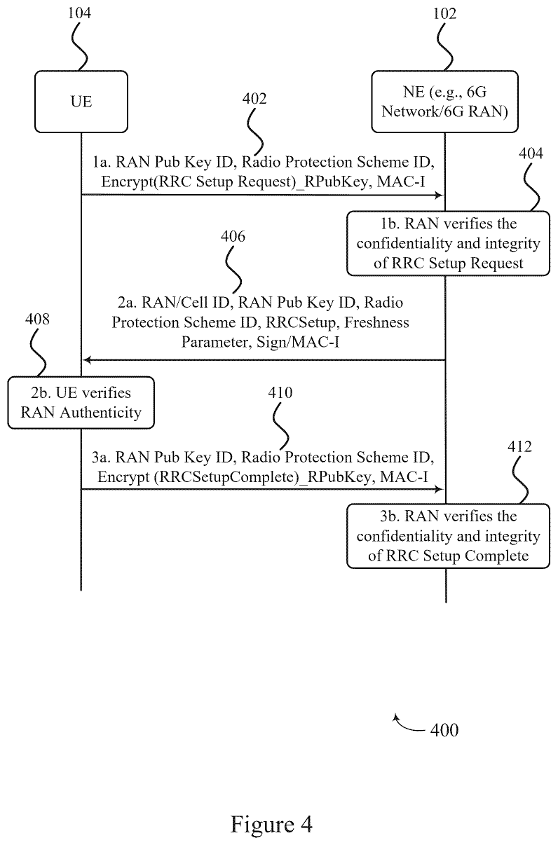

FIG. 4 illustrates an example 400 of base station authentication verification during RRC connection establishment in accordance with aspects of the present disclosure. The example 400 is an example of successful base station (e.g., NE 102) authentication verification using a base station public key based digital signature verification method. The example 400 illustrates a UE 104 and an NE 102 (e.g., a base station, a device of a 6G network or 6G RAN). In the example 400, RAN verification or radio access data protection/security information at the UE 104 can be performed as discussed above with reference to FIG. 3 (e.g., at 302 of FIG. 3). Also in the example 400, RAN verification or radio access data protection/security information at the NE 102 can be performed as discussed above with reference to FIG. 3 (e.g., at 304 of FIG. 3).

At 402, the UE 104 can communicate (e.g., transmit, send, signal, or the like) one or more of the RRC setup request encrypted using the RAN public key and the indicated radio protection scheme/algorithm ID specific to the RAN/cell ID and generate the MAC-I of the encrypted RRC setup request together with RAN public key ID, radio protection scheme/algorithm ID, or a parameter (e.g., that indicates how recent or up-to-date the communication or the information being communicated is). Further the UE 104 communicates (e.g., transmits, sends, signals, or the like) the RAN public key ID, radio protection scheme/algorithm ID, a parameter (e.g., that indicates how recent or up-to-date the communication or the information being communicated is), encrypted RRC setup request and optionally the MAC-I to the NE 102. The parameter (e.g., that indicates how recent or up-to-date the communication or the information being communicated is)can be any one or more of a timestamp, a count (e.g., related to radio signaling connection), a random number, or a nonce value.

Alternatively, or additionally, if a shared secret key is used in encryption of the RRC setup request, the public key of the UE 104 used in the shared secret generation is communicated (e.g., transmitted, sent, signaled, or the like) to the NE 102 along with other information at 402, so that the NE 102 can also generate the shared secret used for RRC setup request decryption, MAC-I generation and verification.

Additionally, if MAC-I is communicated (e.g., transmitted, sent, signaled, or the like) by the UE 104 to the NE 102, the public key of the UE 104 used in the shared secret generation is communicated (e.g., transmitted, sent, signaled, or the like) along with other information at 402 to the NE 102, so that the NE 102 can also generate the shared secret used for MAC-I generation and verification.

Alternatively, or additionally, at 402 the UE 104 instead of using Rpub_Key for encryption can use a pre-provisioned or generated shared secret key to perform encryption and related MAC-I generation. Alternatively, or additionally, the RRC setup request can be communicated (e.g., transmitted, sent, signaled, or the like) in plaintext.

It should be noted that all IEs at 402 can be individual IEs or ones of the IEs can be grouped together, e.g., as an RRC setup request, security information (which may be part of an RRC setup request) and sign/MAC-I. If a digital signature is applied for a message at 402, then the UE 104 uses its private key/pre-provisioned subscriber/subscriber group private key to sign the message. In such a case, the NE 102 at 404 can use the pre-provisioned subscriber/subscriber group public key to verify the signature of the message at 402.

At 404, the NE 102, based on the RAN public key ID, uses the related RAN private key to decrypt the encrypted RRC setup request. Alternatively, if the NE 102 additionally receives a UE public key, the NE 102 generates the shared secret key (or uses a pre-provisioned shared secret key) and performs decryption of the RRC setup request and MAC-I verification using the received information such as RAN public key ID, radio protection scheme/algorithm ID, a parameter (e.g., that indicates how recent or up-to-date the communication or the information being communicated is) and UE public key respectively.

In one or more implementations, if the RRC setup request is plaintext, then the example 400 proceeds directly to 406 and 408 (e.g., RAN verification of confidentiality and integrity of RRC setup request at 404 is not applicable in this case).

At 406, the NE 102 communicates (e.g., transmits, sends, signals, or the like) one or more of the RAN/cell ID, RAN public key ID, radio data protection type indication (indicating digital signature), radio protection algorithm ID(s), RRC set up, or a parameter (e.g., that indicates how recent or up-to-date the communication or the information being communicated is) and their digital signature generated using the RAN private key to protect the integrity of the RRC Set up and for RAN authenticity.

It should be noted that all IEs at 406 can be individual IEs or ones of the IEs can be grouped together, e.g., as an RRC setup message, security information (which may be part of RRC Setup) and sign/MAC-I.

At 408, the UE 104 verifies the digital signature (of the RAN/cell ID, RAN public Key ID, radio data protection type indication (indicating digital signature), radio protection algorithm ID(s), RRC set up, a parameter (e.g., that indicates how recent or up-to-date the communication or the information being communicated is)) based on the RAN verification or, radio access data protection/security information available in the UE 104 (e.g., the digital signature is verified using the RAN public key identified with the RAN public key ID and using the radio protection algorithm indicated by the radio protection algorithm ID). If the digital signature verification is successful, the UE 104 considers the RAN as the authenticated/genuine/authorized RAN to provide the RRC set up to the UE 104, therefore the UE 104 uses the received RRC set up. In one or more implementations, if the digital signature verification is failure the UE 104 can send a RAN authentication failure or a related error message to the NE 102.

At 410, the UE 104 communicates (e.g., transmits, sends, signals, or the like) one or more of the RRC setup complete encrypted using the RAN public key and the indicated radio protection scheme/algorithm ID specific to the RAN/cell ID and generates the MAC-I of the encrypted RRC setup complete together with RAN public key ID, radio protection scheme/algorithm ID, or a parameter (e.g., that indicates how recent or up-to-date the communication or the information being communicated is). Further, the UE 104 communicates (e.g., transmits, sends, signals, or the like) the RAN public key ID, radio protection scheme/algorithm ID, a parameter (e.g., that indicates how recent or up-to-date the communication or the information being communicated is), encrypted RRC setup complete and the optionally MAC-I to the NE 102.

Alternatively, or additionally, if a shared secret key is used in encryption of RRC setup complete, the public key of the UE 104 used in the shared secret generation is communicated (e.g., transmitted, sent, signaled, or the like) to the NE 102 along with other information at 410, so that the NE 102 can also generate the shared secret used for RRC setup complete decryption, MAC-I generation and verification.

Additionally, if MAC-I is communicated (e.g., transmitted, sent, signaled, or the like) by the UE 104 to the NE 102, the public key of the UE 104 used in the shared secret generation is sent along with other information at 410 to the NE 102, so that the NE 102 can also generate the shared secret used for MAC-I generation and verification. Alternatively, or additionally, the RRC setup complete can be communicated (e.g., transmitted, sent, signaled, or the like) in plaintext.

It should be noted that all IEs at 410 can be individual IEs or ones of the IEs can be grouped together, e.g., as RRC setup complete, security information (which may be part of RRC setup complete) and sign/MAC-I. If a digital signature is applied for a message at 410, then the UE 104 uses its private key/pre-provisioned subscriber/subscriber group private key to sign the message. In such a case, the NE 102 at 412 can use the pre-provisioned subscriber/subscriber group public key to verify the signature of the message at 410.

At 412, the NE 102, based on the RAN public key ID, uses the related RAN private key to decrypt the encrypted RRC setup complete. Alternatively, if the NE 102 additionally receives a UE public key, the NE 102 generates the shared secret key and performs decryption of RRC setup complete and MAC-I verification using the received information such as RAN public key ID, radio protection scheme/algorithm ID, a parameter (e.g., that indicates how recent or up-to-date the communication or the information being communicated is) and UE public key respectively.

In one or more implementations, if the RRC setup complete is plaintext, verification of confidentiality and integrity of RRC setup complete at 412 is not applicable or performed.

In one or more implementations, the example 400 uses a shared secret key based base station (e.g., NE 102) provided radio information MAC-I verification method. In such implementations, the example 400 applies the following adaptations. At 406, the NE 102 sends a MAC-I of at least part of the message (e.g., the entire message) instead of a digital signature, where the MAC-I is generated using a shared secret key derived by the NE 102 (e.g., a shared secret key provided for a specific RAN/cell ID, or deriving a shared secret key from the public/private key pair of the NE 102 and using a pre-provisioned subscriber/subscriber group public key). At 408, if the UE 104 receives a MAC-I, the UE 104 uses the pre-provisioned RAN verification key related to the NE 102 (e.g., a shared secret key or a subscriber public/private key pair which can be used by the UE 104 together with the RAN's public key to derive a shared secret key) and verifies the MAC-I for messages received from the NE 102.

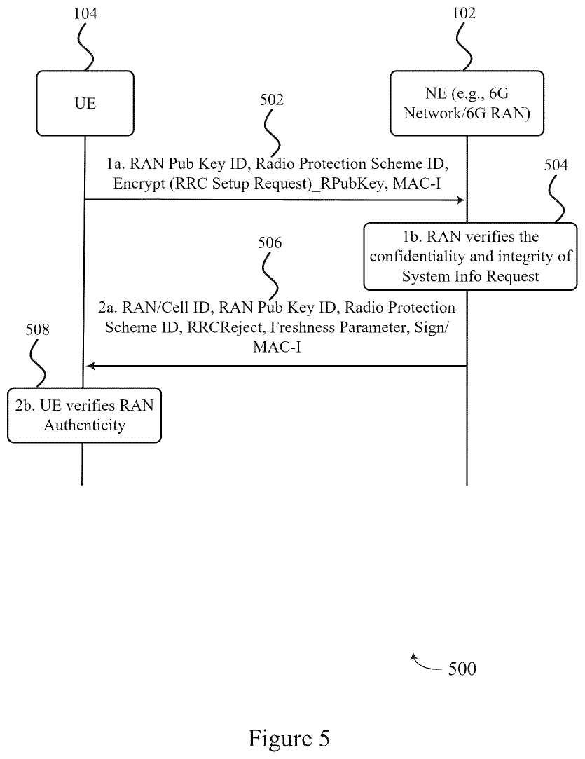

FIG. 5 illustrates an example 500 of base station authentication verification during RRC connection establishment in accordance with aspects of the present disclosure. The example 400 is an example of unsuccessful base station (e.g., NE 102) authentication verification (e.g., a failure case) using a base station public key based digital signature verification method. The example 500 illustrates a UE 104 and an NE 102 (e.g., a base station, a device of a 6G network or 6G RAN). In the example 500, RAN verification or radio access data protection/security information at the UE 104 can be performed as discussed above with reference to FIG. 3 (e.g., at 302 of FIG. 3). Also in the example 500, RAN verification or radio access data protection/security information at the NE 102 can be performed as discussed above with reference to FIG. 3 (e.g., at 304 of FIG. 3).

At 502, the UE 104 can communicate (e.g., transmit, send, signal, or the like) one or more of the RRC setup request encrypted using the RAN public key and the indicated radio protection scheme/algorithm ID specific to the RAN/cell ID and generate the MAC-I of the encrypted RRC setup request together with RAN public key ID, radio protection scheme/algorithm ID, or a parameter (e.g., that indicates how recent or up-to-date the communication or the information being communicated is). Further the UE 104 communicates (e.g., transmits, sends, signals, or the like) the RAN public key ID, radio protection scheme/algorithm ID, a parameter (e.g., that indicates how recent or up-to-date the communication or the information being communicated is), encrypted RRC setup request and optionally the MAC-I to the NE 102.

Alternatively, or additionally, if a shared secret key is used in encryption of the RRC setup request, the public key of the UE 104 used in the shared secret generation is communicated (e.g., transmitted, sent, signaled, or the like) to the NE 102 along with other information at 502, so that the NE 102 can also generate the shared secret used for RRC setup request decryption, MAC-I generation and verification.

Additionally, if MAC-I is communicated (e.g., transmitted, sent, signaled, or the like) by the UE 104 to the NE 102, the public key of the UE 104 used in the shared secret generation is communicated (e.g., transmitted, sent, signaled, or the like) along with other information at 502 to the NE 102, so that the NE 102 can also generate the shared secret used for MAC-I generation and verification.

Alternatively, or additionally, at 402 the UE 104 instead of using Rpub_Key for encryption can use a pre-provisioned or generated shared secret key to perform encryption and related MAC-I generation. Alternatively, or additionally, the RRC setup request can be communicated (e.g., transmitted, sent, signaled, or the like) in plaintext.

At 504, the NE 102, based on the RAN public key ID, uses the related RAN private key to decrypt the encrypted RRC setup request. Alternatively, if the NE 102 additionally receives a UE public key, the NE 102 generates the shared secret key (or uses a pre-provisioned shared secret key) and performs decryption of the RRC setup request and MAC-I verification using the received information such as RAN public key ID, radio protection scheme/algorithm ID, a parameter (e.g., that indicates how recent or up-to-date the communication or the information being communicated is) and UE public key respectively.

In one or more implementations, if the RRC setup request is plaintext, then the example 500 proceeds directly to 506 and 508 (e.g., RAN verification of confidentiality and integrity of RRC setup request at 504 is not applicable in this case).

At 506, if the decryption or MAC-I verification does not succeed, or based on local policy if the NE 102 determines not to allow RRC setup, then the NE 102 communicates (e.g., transmits, sends, signals, or the like) one or more of the RAN/cell ID, RAN public key ID, Radio data protection type indication (indicating digital signature), radio protection algorithm ID(s), RRC Reject, or a parameter (e.g., that indicates how recent or up-to-date the communication or the information being communicated is) and their digital signature generated using the RAN private key to protect the integrity of the RRC Reject and for RAN authenticity.

It should be noted that all IEs at 506 can be individual IEs or ones of the IEs can be grouped together, e.g., as RRC reject, security information (which may be part of RRC reject) and sign/MAC-I.

At 508, the UE 104 verifies the digital signature (of the RAN/cell ID, RAN public key ID, radio data protection type indication (indicating digital signature), radio protection algorithm ID(s), RRC reject, a parameter (e.g., that indicates how recent or up-to-date the communication or the information being communicated is)) based on the RAN verification, or Radio access data protection/security information available in the UE (e.g., the digital signature is verified using the RAN public key identified with the RAN public key ID and using the radio protection algorithm indicated by the radio protection algorithm ID). If the digital signature verification is successful, the UE 104 considers the RAN as the authenticated/genuine/authorized RAN to provide the RRC reject to the UE 104, therefore the UE 104 accepts the received RRC reject. In one or more implementations, if the digital signature verification is failure the UE 104 communicates (e.g., transmits, sends, signals, or the like) a RAN authentication failure or a related error message to the NE 102.

In one or more implementations, the example 400 uses a shared secret key based base station (e.g., NE 102) provided radio information MAC-I verification method. In such implementations, the example 500 applies the following adaptations. At 506, the NE 102 sends a MAC-I of at least part of the message (e.g., the entire message) instead of a digital signature, where the MAC-I is generated using a shared secret key derived by the NE 102 (e.g., a shared secret key provided for a specific RAN/cell ID, or deriving a shared secret key from the public/private key pair of the NE 102 and using a pre-provisioned subscriber/subscriber group public key). At 408, if the UE 104 receives a MAC-I, the UE 104 uses the pre-provisioned RAN verification key related to the NE 102 (e.g., a shared secret key or a subscriber public/private key pair which can be used by the UE 104 together with the RAN's public key to derive a shared secret key) and verifies the MAC-I for messages received from the NE 102.

Returning to FIG. 1, in one or more implementations, a technique to identify an authentic base station during system information provisioning and protect the system information is described. This technique describes how the UE 104 can check whether a base station is authentic, genuine, or authorized during the system information provisioning by the base station while connecting to the RAN (e.g., a 6G network) via the base station. This technique describes different ways to verify the base station authenticity during the RRC connection establishment procedure as follows: using a base station public key based digital signature verification method, or a shared secret key based base station provided radio information MAC-I verification method.

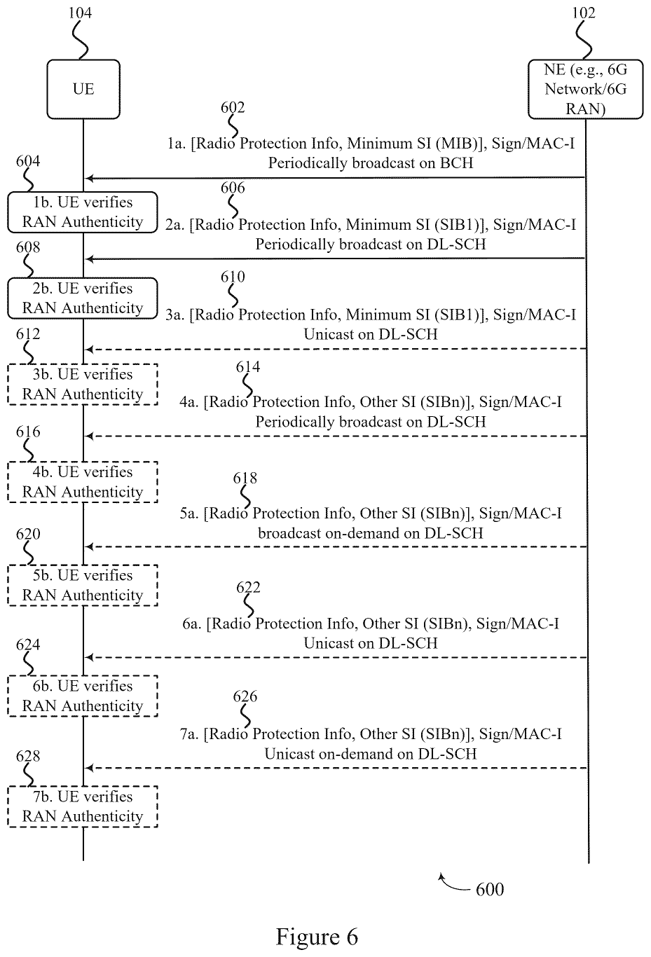

FIG. 6 illustrates an example 600 of base station authentication verification during system information provisioning in accordance with aspects of the present disclosure. The example 600 is an example of a base station public key based digital signature verification method. The example 600 illustrates a UE 104 and an NE 102 (e.g., a base station, a device of a 6G network or 6G RAN). In the example 600, RAN verification or radio access data protection/security information at the UE 104 can be performed as discussed above with reference to FIG. 3 (e.g., at 302 of FIG. 3). Also in the example 600, RAN verification or radio access data protection/security information at the NE 102 can be performed as discussed above with reference to FIG. 3 (e.g., at 304 of FIG. 3).

At 602, the NE 102 sends the radio protection information (e.g., including one or more of RAN/cell ID, RAN public key ID, radio data protection type indication (indicating digital signature), radio protection algorithm ID(s), or a parameter (e.g., that indicates how recent or up-to-date the communication or the information being communicated is)), minimum system information (SI) (MIB), and their digital signature generated using the RAN private key to protect the integrity of the MIB and for RAN authenticity. The MIB at 602 may be communicated (e.g., transmitted, sent, signaled, or the like) periodically as broadcast on broadcast channel (BCH). A parameter (e.g., that indicates how recent or up-to-date the communication or the information being communicated is) can be any one or more of a timestamp, a count (e.g., related to radio signaling connection), a random number, or a nonce value.

At 604, the UE 104 verifies the digital signature (of the radio protection information, e.g., RAN/cell ID, RAN public key ID, radio data protection type indication (indicating digital signature), radio protection algorithm ID(s), a parameter (e.g., that indicates how recent or up-to-date the communication or the information being communicated is)), and minimum SI (MIB), based on the RAN verification, or radio access data protection/security information available in the UE 104 (e.g., the digital signature is verified using the RAN public key identified with the RAN public key ID and using the radio protection algorithm indicated by the radio protection algorithm ID). If the digital signature verification is successful, the UE 104 considers the RAN as the authenticated/genuine/authorized RAN to provide the MIB to the UE 104, therefore the UE 104 uses the received MIB.

The digital signature verification process involves the UE 104 using the RAN public key to decrypt the signature and then comparing the resulting hash value with a hash value calculated from the original message. If the hash values match, the signature is valid, hence the UE 104 confirms both the sender's identity, e.g., RAN/cell ID and the MIB message's integrity. In one or more implementations, if the digital signature verification is failure the UE 104 send a RAN authentication failure or a related error message to the NE 102.

At 606, the NE 102 communicates (e.g., transmits, sends, signals, or the like) the radio protection information (e.g., including one or more of RAN/cell ID, RAN public key ID, radio data protection type indication (indicating digital signature), radio protection algorithm ID(s), or a parameter (e.g., that indicates how recent or up-to-date the communication or the information being communicated is)), minimum SI (SIB1), and their digital signature generated using the RAN private key to protect the integrity of the SIB1 and for RAN authenticity. Here the SIB1 at 606 may be sent periodically as broadcast on downlink shared channel (DL-SCH).

At 608, the UE 104 verifies the digital signature (of the radio protection information, e.g., RAN/cell ID, RAN public key ID, radio data protection type indication (indicating digital signature), radio protection algorithm ID(s), a parameter (e.g., that indicates how recent or up-to-date the communication or the information being communicated is)), and minimum SI (SIB1), based on the RAN verification, or radio access data protection/security information available in the UE 104 (e.g., the digital signature is verified using the RAN public key identified with the RAN public key ID and using the radio protection algorithm indicated by the radio protection algorithm ID). If the digital signature verification is successful, the UE 104 considers the RAN as the authenticated/genuine/authorized RAN to provide the SIB1 to the UE 104, therefore the UE 104 uses the received SIB1. In one or more implementations, if the digital signature verification is failure the UE 104 communicates (e.g., transmits, sends, signals, or the like) a RAN authentication failure or a related error message to the NE 102.

At 610, the NE 102 communicates (e.g., transmits, sends, signals, or the like) the radio protection information (e.g., including one or more of RAN/cell ID, RAN public key ID, radio data protection type indication (indicating digital signature), radio protection algorithm ID(s), or a parameter (e.g., that indicates how recent or up-to-date the communication or the information being communicated is)), minimum SI (SIB1), and their digital signature generated using the RAN private key to protect the integrity of the SIB1 and for RAN authenticity. Here the SIB1 at 610 may be sent as Unicast on DL-SCH.

At 612, the UE 104 verifies the digital signature (of the radio protection information, e.g., RAN/cell ID, RAN public key ID, radio data protection type indication (indicating digital signature), radio protection algorithm ID(s), a parameter (e.g., that indicates how recent or up-to-date the communication or the information being communicated is)), and minimum SI (SIB1), based on the RAN verification, or radio access data protection/security information available in the UE 104, e.g., the digital signature is verified using the RAN public key identified with the RAN public key ID and using the radio protection algorithm indicated by the radio protection algorithm ID. If the digital signature verification is successful, the UE 104 considers the RAN as the authenticated/genuine/authorized RAN to provide the SIB1 to the UE 104, therefore the UE 104 uses the received SIB1. In one or more implementations, if the digital signature verification is failure, the UE 104 communicates (e.g., transmits, sends, signals, or the like) a RAN authentication failure or a related error message to the NE 102.

At 614, the NE 102 communicates (e.g., transmits, sends, signals, or the like) the radio protection information (e.g., including one or more of RAN/cell ID, RAN public key ID, radio data protection type indication (indicating digital signature), radio protection algorithm ID(s), or a parameter (e.g., that indicates how recent or up-to-date the communication or the information being communicated is)), other SI (SIBn), and their digital signature generated using the RAN private key to protect the integrity of the SIBn and for RAN authenticity. Here the SIBn at 614 may be sent periodically as broadcast on DL-SCH.

At 616, the UE 104 verifies the digital signature (of the radio protection information, e.g., RAN/cell ID, RAN public key ID, radio data protection type indication (indicating digital signature), radio protection algorithm ID(s), a parameter (e.g., that indicates how recent or up-to-date the communication or the information being communicated is)), and other SI (SIBn), based on the RAN verification, or radio access data protection/security information available in the UE 104, e.g., the digital signature is verified using the RAN public key identified with the RAN public key ID and using the radio protection algorithm indicated by the radio protection algorithm ID. If the digital signature verification is successful, the UE 104 considers the RAN as the authenticated/genuine/authorized RAN to provide the SIBn to the UE 104, therefore the UE 104 uses the received SIBn. In one or more implementations, if the digital signature verification is failure, the UE 104 communicates (e.g., transmits, sends, signals, or the like) a RAN authentication failure or a related error message to the NE 102.

At 618, the NE 102 communicates (e.g., transmits, sends, signals, or the like) the radio protection information (e.g., including one or more of RAN/cell ID, RAN public key ID, radio data protection type indication (indicating digital signature), radio protection algorithm ID(s), or a parameter (e.g., that indicates how recent or up-to-date the communication or the information being communicated is)), other SI (SIBn), and their digital signature generated using the RAN private key to protect the integrity of the SIBn and for RAN authenticity. Here the SIBn at 618 may be sent as broadcast on-demand on DL-SCH.

At 620, the UE 104 verifies the digital signature (of the radio protection information, e.g., RAN/cell ID, RAN public key ID, radio data protection type indication (indicating digital signature), radio protection algorithm ID(s), a parameter (e.g., that indicates how recent or up-to-date the communication or the information being communicated is)), and other SI (SIBn), based on the RAN verification, or radio access data protection/security information available in the UE 104, e.g., the digital signature is verified using the RAN public key identified with the RAN public key ID and using the radio protection algorithm indicated by the radio protection algorithm ID. If the digital signature verification is successful, the UE 104 considers the RAN as the authenticated/genuine/authorized RAN to provide the SIBn to the UE 104, therefore the UE 104 uses the received SIBn. In one or more implementations, if the digital signature verification is failure, the UE 104 communicates (e.g., transmits, sends, signals, or the like) a RAN authentication failure or a related error message to the NE 102.

At 622, the NE 102 communicates (e.g., transmits, sends, signals, or the like) the radio protection information (e.g., including one or more of RAN/cell ID, RAN public key ID, radio data protection type indication (indicating digital signature), radio protection algorithm ID(s), or a parameter (e.g., that indicates how recent or up-to-date the communication or the information being communicated is)), other SI (SIBn), and their digital signature generated using the RAN private key to protect the integrity of the SIBn and for RAN authenticity. Here the SIBn at 622 may be sent as unicast on DL-SCH.

At 624, the UE 104 verifies the digital signature (of the radio protection information, e.g., RAN/cell ID, RAN public key ID, radio data protection type indication (indicating digital signature), radio protection algorithm ID(s), a parameter (e.g., that indicates how recent or up-to-date the communication or the information being communicated is)), and other SI (SIBn), based on the RAN verification, or radio access data protection/security information available in the UE 104, e.g., the digital signature is verified using the RAN public key identified with the RAN public key ID and using the radio protection algorithm indicated by the radio protection algorithm ID. If the digital signature verification is successful, the UE 104 considers the RAN as the authenticated/genuine/authorized RAN to provide the SIBn to the UE 104, therefore the UE 104 uses the received SIBn. In one or more implementations, if the digital signature verification is failure, the UE 104 communicates (e.g., transmits, sends, signals, or the like) a RAN authentication failure or a related error message to the NE 102.

At 626, the NE 102 communicates (e.g., transmits, sends, signals, or the like) the radio protection information (e.g., including one or more of RAN/cell ID, RAN public key ID, radio data protection type indication (indicating digital signature), radio protection algorithm ID(s), or a parameter (e.g., that indicates how recent or up-to-date the communication or the information being communicated is)), other SI (SIBn), and their digital signature generated using the RAN private key to protect the integrity of the SIBn and for RAN authenticity. Here the SIBn at 626 may be sent as unicast on-demand on DL-SCH.

At 628, the UE 104 verifies the digital signature (of the radio protection information, e.g., RAN/cell ID, RAN public key ID, radio data protection type indication (indicating digital signature), radio protection algorithm ID(s), a parameter (e.g., that indicates how recent or up-to-date the communication or the information being communicated is)), and other SI (SIBn), based on the RAN verification, or radio access data protection/security information available in the UE 104, e.g., the digital signature is verified using the RAN public key identified with the RAN public key ID and using the radio protection algorithm indicated by the radio protection algorithm ID. If the digital signature verification is successful, the UE 104 considers the RAN as the authenticated/genuine/authorized RAN to provide the SIBn to the UE 104, therefore the UE 104 uses the received SIBn. In one or more implementations, if the digital signature verification is failure the UE 104 communicates (e.g., transmits, sends, signals, or the like) a RAN authentication failure or a related error message to the NE 102.

In one or more implementations, the example 400 uses a shared secret key based base station (e.g., NE 102) provided radio information MAC-I verification method. In such implementations, the example 600 applies the following adaptations. At 602, 606, 610, 614, 618, 622, and 626, the NE 102 communicates (e.g., transmits, sends, signals, or the like) a MAC-I of at least part of the message (e.g., the entire message) instead of digital signature, where the MAC-I is generated using a shared secret key derived by the NE 102 (e.g., a shared secret key provided for a specific RAN/cell ID, or deriving a shared secret key from the public/private key pair of the NE 102 and using a pre-provisioned subscriber/subscriber group public key). At 604, 608, 612, 616, 620, 624, and 628, if the UE 104 receives a MAC-I, the UE 104 uses the pre-provisioned RAN verification key related to the NE 102 (e.g., a shared secret key or a subscriber public/private key pair which can be used by the UE 104 together with the RAN's public key to derive a shared secret key) and verifies the MAC-I for messages received from the NE 102.

Returning to FIG. 1, in one or more implementations, a technique to identify and check the authenticity of a base station via certificate or digital credentials validation using a DLT, such as blockchain, during any initial RAN access is described. This technique describes how the UE 104 can check whether a base station is authentic, genuine, or authorized while connecting to the RAN (e.g., a 6G network) via the base station. The techniques uses RAN security credentials managed in a mobile network operator (MNO) consortium/governance based blockchain or PDL ledger/repository during any RRC procedure (e.g., system information provisioning or RRC Setup). This technique describes different ways to verify the base station authenticity during the RRC connection establishment or any system information provisioning/acquisition procedure as follows: using a base station public key based digital signature verification method, or a shared secret key based base station provided radio information MAC-I verification method.

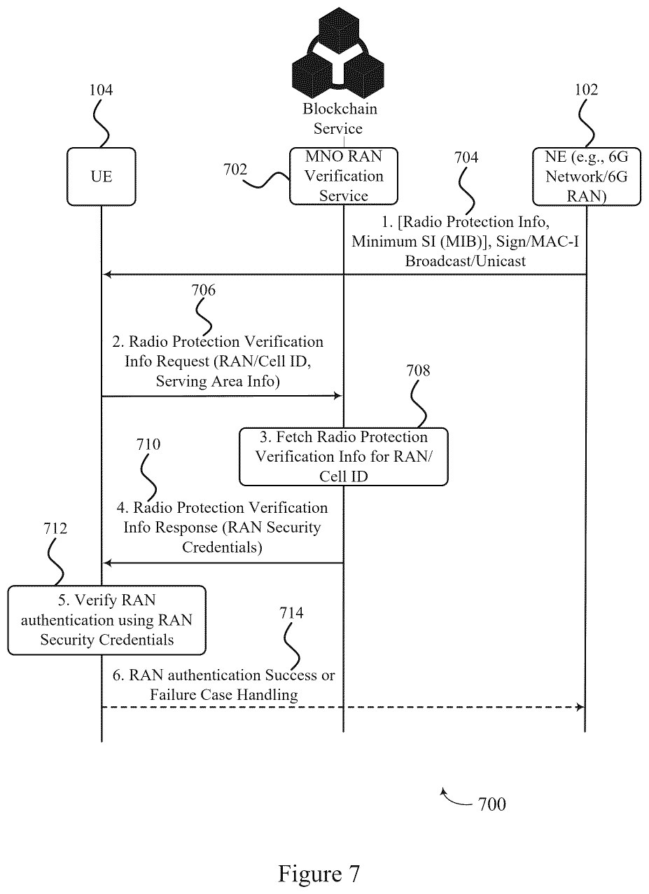

FIG. 7 illustrates an example 700 of base station authentication verification using a DLT in accordance with aspects of the present disclosure. The example 700 is an example of base station authentication verification using a blockchain/DLT during any AS/RRC information provision or connection establishment. The example 700 illustrates a UE 104, an NE 102 (e.g., a base station, a device of a 6G network or 6G RAN), and a MNO RAN verification service 702 (e.g., using a DLT, such as blockchain).

RAN verification or radio access data protection/security information at the UE 104 can be performed as discussed above with reference to FIG. 3 (e.g., at 302 of FIG. 3), including the UE/USIM being provisioned with a list or set of authorized RAN node IDs, and serving area and cell ID(s) information along with RAN data protection/security information (also referred to as radio data protection). A parameter (e.g., that indicates how recent or up-to-date the communication or the information being communicated is) as discussed with reference to example 700 can be any one or more of a timestamp, a count (e.g., related to radio signaling connection), a random number, or a nonce value.

With respect to RAN verification or radio access data protection/security information at the UE 104, the UE/USIM is provisioned with the following information by the mobile network operator (e.g., the home network or serving network) to perform RAN verification or radio access data protection/security at the UE side. The information includes a list, set, or identification of authorized RAN node/base station identifier(s) (e.g., 6G-NCI), which may consist of base station ID (BS ID, e.g., 6G gNB ID/6G Node ID) and cell ID) along with information specific to the RAN node/base station, such as one or more of related cell identifiers, specific serving area information, MNO RAN verification service address, any preconfigured MNO ID, RAN security information, radio security capabilities, or radio data protection type indicator. The related cell identifier refers to, for example, a PCI, a general cell ID, or the like. A specific serving area information refers to, for example, a TAC, a TAI and a cell global identity (e.g., PLMN ID/NPN-ID and 6G-NCI), or the like. The RAN security information refers to, for example, a RAN public key/certificate along with the RAN public key ID. In the case of a certificate, the root CA certificate is also provided for RAN Certificate verification.

A MNO RAN verification service address refers to a service address or fully qualified domain name (FQDN) related to a function offered by the MNO (e.g., the MNO governance/consortium network which facilitates RAN verification service). Any preconfigured MNO ID refers to any preconfigured MNO UE RADIO ID/MNO ID (e.g., an ID authorized by the MNO) to request this verification service. The RAN security information refers to, for example, a latest RAN public key/latest RAN server certificate along with RAN public key ID (as well CA issuer certificate to validate the RAN server certificate, in the case of certificate, the root CA certificate is also provided for RAN certificate verification.). The RAN security information can also include a time stamp or lifetime or validity for the RAN security information.

The radio security capabilities refers to one or more radio information protection algorithms and related algorithm IDs, such as an NIST PQC algorithm, an NIST PQC Key encapsulation mechanism, an NIST PQC public-key encryption algorithm, a symmetric encryption algorithm, or an ECIES. The NIST PQC algorithm for signatures can include at least one of the following and the related signature scheme IDs: Cystals-Dilithium/ML-DSA, FALCON, or SPHINCS+/SLH-DSA. The NIST PQC Key encapsulation mechanisms can include mechanisms to establish shared secret key between the UE and the RAN over a public channel and the related algorithm/protection scheme ID(s). ML-KEM can be offered in any one or more of multiple (e.g., three) parameters sets, such as ML-KEM-512, ML-KEM-768, or ML-KEM-1024. The NIST PQC public-key encryption algorithm, e.g., as backup to ML-KEM, and its related algorithm Identifier(s) can include, for example, HQC. The symmetric encryption algorithm and related algorithm IDs can include, for example, one or more of AES, ZUC, or SNOW-3G.

The radio data protection type indicator refers to, for example, need digital signature verification only, need encryption for confidentiality protection only, need MAC-I verification for integrity protection only, both confidentiality protection and integrity protection needed, or the like. The need digital signature verification only refers to, for example, an authentication check (e.g., by means of public/private key pairs). The need encryption for confidentiality protection only refers to, for example, shared secret generation using a key encapsulation protocol (e.g., ML-KEM) and then using a symmetric algorithm to encrypt the message (e.g., AES), or, using a public key to encrypt the message (e.g., HQC), or using the public key of the receiver, generating a shared secret by generating a sender's ephemeral public/private key pair compute encryption and MAC-Tag (e.g., using ECIES). The need MAC-I verification for integrity protection only refers to, for example, shared secret generation using a key encapsulation protocol (e.g., ML-KEM) and then using a symmetric algorithm to generate the MAC-I of the message (e.g., AES/ZUC/SNOW-3G), or, using the public key of the receiver, generating a shared secret by generating a sender's ephemeral public/private key pair compute encryption and MAC-Tag (e.g., using ECIES).

At 704, the NE 102 can communicate (e.g., transmit, send, signal, or the like) one or more of the radio protection information (e.g., including one or more of RAN/cell ID, RAN public key ID, radio data protection type indication (indicating digital signature), radio protection algorithm ID(s), or a parameter (e.g., that indicates how recent or up-to-date the communication or the information being communicated is)), Minimum SI (MIB), and their digital signature generated using the RAN private key to protect the integrity of the MIB and for RAN authenticity. Here the MIB at 704 may be sent in broadcast or unicast on any radio channel.

At 706, the UE 104, on receiving the MIB from the NE 102 (or on lifetime expiry of available RAN security information (if available) or on absence of the RAN security information), can communicate (e.g., transmit, send, signal, or the like) a radio protection verification information request to the MNO RAN Verification service function using the configured MNO RAN verification service address/FQDN, where the RAN protection verification service includes one or more of RAN/cell ID, serving area Information and/or any preconfigured MNO UE RADIO ID/MNO ID to request this Verification Service.

At 708, the MNO RAN verification service function fetches the radio protection verification information related to the specific RAN/cell ID, where it maintains the latest RAN security credentials as follows. The MNO RAN verification service 702 function is provisioned with the following information by the mobile network operator (home network or serving network) to perform RAN verification, or radio access data protection/security at the UE side. The information includes a list, set, or identification of authorized RAN node/base station Identifier(s) (e.g., 6G-NCI, which may consist of base station ID (BS ID, e.g., 6G gNB ID/ 6G Node ID) and Cell ID(s) along with the following information specific to the RAN node/base station, such as one or more of related cell identifiers, specific serving area information, MNO RAN verification service address, any preconfigured MNO ID, RAN security information, radio security capabilities, or radio data protection type indicator. The related cell identifier refers to, for example, a PCI, a general cell ID, or the like. A specific serving area information refers to, for example, a TAC, a TAI and a cell global identity (e.g., PLMN ID/NPN-ID and 6G-NCI), or the like.

A MNO RAN verification service address refers to a service address or FQDN related to a function offered by the MNO (e.g., the MNO governance/consortium network which facilitates RAN verification service). Any preconfigured MNO ID refers to any preconfigured MNO UE RADIO ID/MNO ID (e.g., an ID authorized by the MNO) to request this verification service. The RAN security information (which may be optional) refers to, for example, a latest RAN public key or latest RAN server certificate along with RAN public key ID (as well CA issuer certificate to validate the RAN server certificate, in the case of certificate, the root CA certificate is also provided for RAN certificate verification.). The RAN security information can also include a time stamp or lifetime or validity for the RAN security information.

The radio security capabilities, which may be optional, refers to one or more radio information protection algorithms and related algorithm IDs, such as an NIST PQC algorithm, an NIST PQC Key encapsulation mechanism, an NIST PQC public-key encryption algorithm, a symmetric encryption algorithm, or an ECIES. The NIST PQC algorithm for signatures can include at least one of the following and the related signature scheme IDs: Cystals-Dilithium/ML-DSA, FALCON, or SPHINCS+/SLH-DSA. The NIST PQC Key encapsulation mechanisms can include mechanisms to establish shared secret key between the UE and the RAN over a public channel and the related algorithm/protection scheme ID(s). ML-KEM can be offered in any one or more of multiple (e.g., three) parameters sets, such as ML-KEM-512, ML-KEM-768, or ML-KEM-1024. The NIST PQC public-key encryption algorithm, e.g., as backup to ML-KEM, and its related algorithm Identifier(s) can include, for example, HQC. The symmetric encryption algorithm and related algorithm IDs can include, for example, one or more of AES, ZUC, or SNOW-3G.

The radio data protection type indicator, which may be optional, refers to, for example, need digital signature verification only, need encryption for confidentiality protection only, need MAC-I verification for integrity protection only, both confidentiality protection and integrity protection needed, or the like. The need digital signature verification only refers to, for example, an authentication check (e.g., by means of public/private key pairs). The need encryption for confidentiality protection only refers to, for example, shared secret generation using a key encapsulation protocol (e.g., ML-KEM) and then using a symmetric algorithm to encrypt the message (e.g., AES), or, using a public key to encrypt the message (e.g., HQC), or using the public key of the receiver, generating a shared secret by generating a sender's ephemeral public/private key pair compute encryption and MAC-Tag (e.g., using ECIES). The need MAC-I verification for integrity protection only refers to, for example, shared secret generation using a key encapsulation protocol (e.g., ML-KEM) and then using a symmetric algorithm to generate the MAC-I of the message (e.g., AES/ZUC/SNOW-3G), or, using the public key of the receiver, generating a shared secret by generating a sender's ephemeral public/private key pair compute encryption and MAC-Tag (e.g., using ECIES).

At 710, the MNO RAN verification service 702 function sends the RAN protection verification information response message to the UE 104, which includes the RAN security credentials (one or more of the latest public key of RAN/latest valid certificate of RAN, root CA certificate who issued the RAN certificate to validate the RAN certificate, selected radio information protection algorithms and related algorithm IDs, selected radio data protection type Indicator, validity/lifetime, or any additional information which can help in radio protection information verification) related to the RAN/cell ID received from the UE 104.

At 712, the UE 104 verifies the digital signature (of the radio protection information, e.g., one or more of RAN/cell ID, RAN public key ID, radio data protection type indication (indicating digital signature), radio protection algorithm ID(s), or a parameter (e.g., that indicates how recent or up-to-date the communication or the information being communicated is)), and Minimum SI (MIB), based on the RAN verification, or radio access data protection/security information available in the UE 104 and fetched from the MNO RAN verification service 702 function, e.g., the digital signature is verified using the RAN public key identified with the RAN public key ID and using the radio protection algorithm indicated by the radio protection algorithm ID.

It should be noted that the digital signature verification process involves the UE 104 using the RAN public key to decrypt the signature and then comparing the resulting hash value with a hash value calculated from the original message. If the hash values match, the signature is valid, hence the UE 104 confirms both the sender's identity, e.g., RAN/cell ID and the MIB message's integrity.

At 714, if the digital signature verification is successful, the UE 104 considers the RAN as the authenticated, genuine, or authorized RAN to provide the MIB to the UE 104, therefore the UE 104 uses the received MIB. In one or more implementations, if the digital signature verification is failure the UE 104 send a RAN authentication failure or a related error message to the RAN.

In one or more implementations, the example 700 uses a shared secret key based base station (e.g., NE 102) provided radio information MAC-I verification method. In such implementations, the example 700 applies with the following adaptations. At 704, the NE 102 sends a MAC-I of at least part of the message (e.g., the entire message) message instead of digital signature, where the MAC-I is generated using a shared secret key derived by the NE 102 (e.g., a shared secret key provided for a specific RAN/cell ID, or deriving a shared secret key from the public/private key pair of the NE 102 and using a pre-provisioned subscriber/subscriber group public key). At 712, if the UE 104 receives a MAC-I, the UE 104 uses the pre-provisioned RAN verification key (fetched at 710) related to the NE 102 (e.g., a shared secret key or a subscriber public/private key pair which can be used by the UE 104 together with the RAN's public key (fetched at 710) to derive a shared secret key) and verifies the MAC-I for messages received from the NE 102.

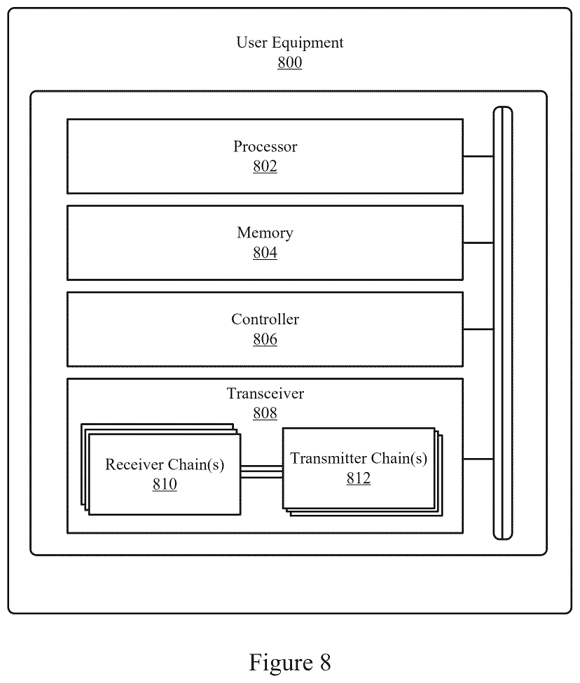

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for receiving system information and protection information for a RAN node; and verifying, based at least in part on a digital signature of the protection information or a MAC-I of the protection information, an authenticity of the RAN node.

Additionally, the UE 800 may be configured to support any one or combination of receiving a set of authorized RAN node IDs, serving area and cell ID information, and RAN data protection or security information; where receiving the system information includes receiving a MIB, and where verifying the authenticity of the RAN node includes verifying the authenticity of the RAN node based at least in part on one or more of a set of authorized RAN node IDs, a set of cell IDs, or protection information; where receiving the system information includes receiving a SIB1, and where verifying the authenticity of the RAN node includes verifying the authenticity of the RAN node based at least in part on one or more of a set of authorized RAN node IDs, a set of cell IDs, or protection information; where the protection information comprises an identifier of a protection algorithm; receiving information including an ID associated with the RAN node, and a parameter, where the ID comprises one or more of a RAN node ID, a cell ID, or a public key ID, where the parameter indicates how recent or up-to-date the information is, where receiving the system information includes receiving a RRC setup message, and where verifying the authenticity of the RAN node includes verifying the authenticity of the RAN node based at least in part on the public key ID and the protection algorithm; where the digital signature comprises a digital signature of one or more of: an information block, the RRC setup message, the protection information, the RAN node ID, the cell ID, the public key ID, or the parameter; where receiving the system information includes receiving a RRC setup message.

Additionally, or alternatively, the UE 800 may support at least one memory (e.g., the memory 804) and at least one processor (e.g., the processor 802) coupled with the at least one memory and operable to or configured to cause the UE to: receive system information and protection information for a RAN node; and verify, based at least in part on a digital signature of the protection information or a MAC-I of the protection information, an authenticity of the RAN node.

Additionally, the UE 800 may be configured to support any one or combination of where the at least one processor is operable or configured to cause the UE to receive a set of authorized RAN node IDs, serving area and cell ID information, and RAN data protection or security information; where to receive the system information, the at least one processor is operable or configured to cause the UE to receive a MIB, and where to verify the authenticity of the RAN node, the at least one processor is operable or configured to cause the UE to verify the authenticity of the RAN node based at least in part on one or more of a set of authorized RAN node IDs, a set of cell IDs, or protection information; where to receive the system information, the at least one processor is operable or configured to cause the UE to receive a SIB1, and where to verify the authenticity of the RAN node, the at least one processor is operable or configured to cause the UE to verify the authenticity of the RAN node based at least in part on one or more of a set of authorized RAN node IDs, a set of cell IDs, or protection information; where the protection information comprises an identifier of a protection algorithm; where the at least one processor is further operable or configured to cause the UE to receive information including an ID associated with the RAN node, and a parameter, where the ID comprises one or more of a RAN node ID, a cell ID, or a public key ID, where the parameter indicates how recent or up-to-date the information is, where to receive the system information, the at least one processor is operable or configured to cause the UE to receive a RRC setup message, and where to verify the authenticity of the RAN node, the at least one processor is operable or configured to cause the UE to verify the authenticity of the RAN node based at least in part on the public key ID and the protection algorithm; where the digital signature comprises a digital signature of one or more of: an information block, the RRC setup message, the protection information, the RAN node ID, the cell ID, the public key ID, or the parameter; where to receive the system information, the at least one processor is operable or configured to cause the UE to receive a RRC setup message.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for receiving protection information for a RAN node; transmitting a protection verification information request that includes a RAN or cell ID for the RAN node; receiving a protection verification information response that includes security credentials for the RAN node; verifying, based at least in part on the protection information for the RAN node and the security credentials for the RAN node, an authenticity of the RAN node.

Additionally, the UE 800 may be configured to support any one or combination of where the protection information comprises an identifier of a information protection algorithm; where the security credentials for the RAN node comprise at least one of a latest public key of the RAN node, a latest valid certificate of the RAN node, a root certificate authority (CA) certificate of an issuer of the latest valid certificate of the RAN node, one or more selected protection algorithms and related algorithm IDs, a selected protection type indicator, or a validity or lifetime of the latest public key of the RAN; where verifying the authenticity of the RAN node includes verifying the authenticity of the RAN node based at least in part on a digital signature of the protection information or a MAC-I of the protection information; verifying the authenticity of the RAN node based at least in part on one or more of a list of authorized RAN IDs, cell IDs, or protection information; where transmitting the protection verification information request includes transmitting the protection verification request to a verification service, and receiving the protection verification information response includes receiving the protection verification information response from the verification service.

Additionally, or alternatively, the UE 800 may support at least one memory (e.g., the memory 804) and at least one processor (e.g., the processor 802) coupled with the at least one memory and operable to or configured to cause the UE to: receive protection information for a RAN node; transmit a protection verification information request that includes a RAN or cell ID for the RAN node; receive a protection verification information response that includes security credentials for the RAN node; verify, based at least in part on the protection information for the RAN node and the security credentials for the RAN node, an authenticity of the RAN node.

Additionally, the UE 800 may be configured to support any one or combination of where the protection information comprises an identifier of a information protection algorithm; where the security credentials for the RAN node comprise at least one of a latest public key of the RAN node, a latest valid certificate of the RAN node, a root CA certificate of an issuer of the latest valid certificate of the RAN node, one or more selected protection algorithms and related algorithm IDs, a selected protection type indicator, or a validity or lifetime of the latest public key of the RAN; where to verify the authenticity of the RAN node, the at least one processor is further operable or configured to cause the UE to verify the authenticity of the RAN node based at least in part on a digital signature of the protection information or a MAC-I of the protection information; where the at least one processor is operable or configured to cause the UE to verify the authenticity of the RAN node based at least in part on one or more of a list of authorized RAN IDs, cell IDs, or protection information; where to transmit the protection verification information request, the at least one processor is operable or configured to cause the UE to transmit the protection verification request to a verification service, and where to receive the protection verification information response, the at least one processor is operable or configured to cause the UE to receive the protection verification information response from the verification service.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

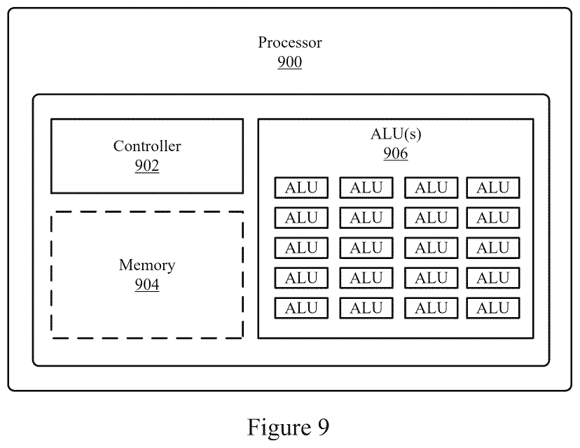

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to, capable of, or operable to cause the processor to: receive system information and protection information for a RAN node; and verify, based at least in part on a digital signature of the protection information or a MAC-I of the protection information, an authenticity of the RAN node.

Additionally, the processor 900 may be configured to or operable to support any one or combination of where the at least one controller is operable or configured to cause the processor to receive a set of authorized RAN node IDs, serving area and cell ID information, and RAN data protection or security information; where to receive the system information, the at least one controller is operable or configured to cause the processor to receive a MIB, and where to verify the authenticity of the RAN node, the at least one controller is operable or configured to cause the processor to verify the authenticity of the RAN node based at least in part on one or more of a set of authorized RAN node IDs, a set of cell IDs, or protection information; where to receive the system information, the at least one controller is operable or configured to cause the processor to receive a SIB1, and where to verify the authenticity of the RAN node, the at least one controller is operable or configured to cause the processor to verify the authenticity of the RAN node based at least in part on one or more of a set of authorized RAN node IDs, a set of cell IDs, or protection information; where the protection information comprises an identifier of a protection algorithm; where the at least one controller is further operable or configured to cause the processor to receive information including an ID associated with the RAN node, and a parameter, where the ID comprises one or more of a RAN node ID, a cell ID, or a public key ID, where the parameter indicates how recent or up-to-date the information is, where to receive the system information, the at least one controller is operable or configured to cause the processor to receive a RRC setup message, and where to verify the authenticity of the RAN node, the at least one controller is operable or configured to cause the processor to verify the authenticity of the RAN node based at least in part on the public key ID and the protection algorithm; where the digital signature comprises a digital signature of one or more of: an information block, the RRC setup message, the protection information, the RAN node ID, the cell ID, the public key ID, or the parameter; where to receive the system information, the at least one controller is operable or configured to cause the processor to receive a RRC setup message.

The processor 900 may support wireless communication in accordance with examples as disclosed herein. The processor 900 may be configured to or operable to support at least one controller (e.g., the controller 902) coupled with at least one memory (e.g., the memory 904) and configured to, capable of, or operable to cause the processor to: receive protection information for a RAN node; transmit a protection verification information request that includes a RAN or cell ID for the RAN node; receive a protection verification information response that includes security credentials for the RAN node; verify, based at least in part on the protection information for the RAN node and the security credentials for the RAN node, an authenticity of the RAN node.

Additionally, the processor 900 may be configured to or operable to support any one or combination of where the protection information comprises an identifier of a information protection algorithm; where the security credentials for the RAN node comprise at least one of a latest public key of the RAN node, a latest valid certificate of the RAN node, a root CA certificate of an issuer of the latest valid certificate of the RAN node, one or more selected protection algorithms and related algorithm IDs, a selected protection type indicator, or a validity or lifetime of the latest public key of the RAN; where to verify the authenticity of the RAN node, the at least one controller is further operable or configured to cause the processor to verify the authenticity of the RAN node based at least in part on a digital signature of the protection information or a MAC-I of the protection information; where the at least one controller is operable or configured to cause the processor to verify the authenticity of the RAN node based at least in part on one or more of a list of authorized RAN IDs, cell IDs, or protection information; where to transmit the protection verification information request, the at least one controller is operable or configured to cause the processor to transmit the protection verification request to a verification service, and where to receive the protection verification information response, the at least one controller is operable or configured to cause the processor to receive the protection verification information response from the verification service.

The processor 900 may support wireless communication in accordance with examples as disclosed herein. The processor 900 may be configured to or operable to support at least one controller (e.g., the controller 902) coupled with at least one memory (e.g., the memory 904) and configured to, capable of, or operable to cause the processor to: transmit system information and protection information for a RAN node.

Additionally, the processor 900 may be configured to or operable to support any one or combination of where the processor is provisioned with an authorized RAN node ID, serving area and cell ID information, and RAN data protection or security information; where the protection information comprises an identifier of a protection algorithm; where the at least one controller is further operable or configured to cause the processor to transmit information including a RAN or cell ID for the RAN node, a public key ID for the RAN node, and a parameter that indicates how recent or up-to-date the information is.

The processor 900 may support wireless communication in accordance with examples as disclosed herein. The processor 900 may be configured to or operable to support at least one controller (e.g., the controller 902) coupled with at least one memory (e.g., the memory 904) and configured to, capable of, or operable to cause the processor to: transmit protection information for a RAN node; receive a protection verification information request that includes a RAN or cell ID for the RAN node; transmit a radio protection verification information response that includes security credentials for the RAN node.

Additionally, the processor 900 may be configured to or operable to support any one or combination of where the security credentials for the RAN node comprise at least one of a latest public key of the RAN node, a latest valid certificate of the RAN node, a root CA certificate of an issuer of the latest valid certificate of the RAN node, one or more selected protection algorithms and related algorithm IDs, a selected protection type indicator, or a validity or lifetime of the latest public key of the RAN.

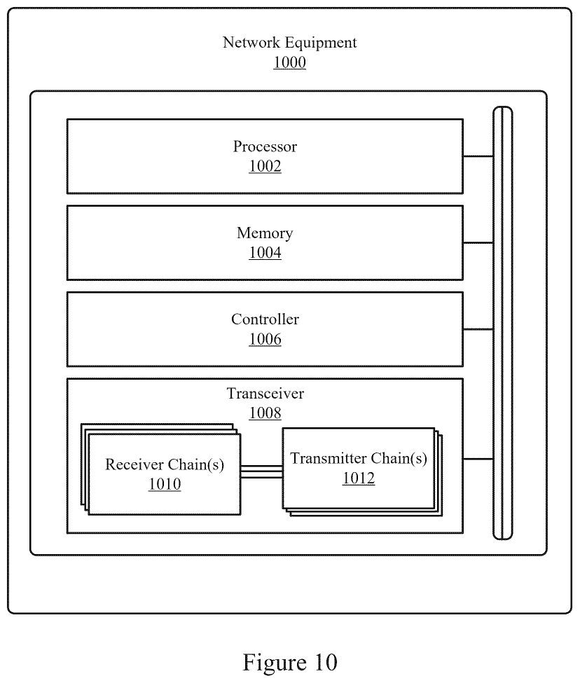

FIG. 10 illustrates an example of an NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for transmitting system information and protection information for a RAN node.

Additionally, the NE 1000 may be configured to support any one or combination of where the NE is provisioned with an authorized RAN node ID, serving area and cell ID information, and RAN data protection or security information; where the protection information comprises an identifier of a protection algorithm; where transmitting information including a RAN or cell ID for the RAN node, a public key ID for the RAN node, and a parameter that indicates how recent or up-to-date the information is.

Additionally, or alternatively, the NE 1000 may support at least one memory (e.g., the memory 1004) and at least one processor (e.g., the processor 1002) coupled with the at least one memory and configured to, capable of, or operable to cause the NE to: transmit system information and protection information for a RAN node.

Additionally, the NE 1000 may be configured to support any one or combination of where the NE is provisioned with an authorized RAN node ID, serving area and cell ID information, and RAN data protection or security information; where the protection information comprises an identifier of a protection algorithm; where the at least one processor is further operable or configured to cause the NE to transmit information including a RAN or cell ID for the RAN node, a public key ID for the RAN node, and a parameter that indicates how recent or up-to-date the information is.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means transmitting protection information for a RAN node; receiving a protection verification information request that includes a RAN or cell ID for the RAN node; transmitting a radio protection verification information response that includes security credentials for the RAN node.

Additionally, the NE 1000 may be configured to support any one or combination of where the security credentials for the RAN node comprise at least one of a latest public key of the RAN node, a latest valid certificate of the RAN node, a root certificate authority (CA) certificate of an issuer of the latest valid certificate of the RAN node, one or more selected protection algorithms and related algorithm IDs, a selected protection type indicator, or a validity or lifetime of the latest public key of the RAN.

Additionally, or alternatively, the NE 1000 may support at least one memory (e.g., the memory 1004) and at least one processor (e.g., the processor 1002) coupled with the at least one memory and configured to, capable of, or operable to cause the NE to: transmit protection information for a RAN node; receive a protection verification information request that includes a RAN or cell ID for the RAN node; transmit a radio protection verification information response that includes security credentials for the RAN node.

Additionally, the NE 1000 may be configured to support any one or combination of where the security credentials for the RAN node comprise at least one of a latest public key of the RAN node, a latest valid certificate of the RAN node, a root certificate authority (CA) certificate of an issuer of the latest valid certificate of the RAN node, one or more selected protection algorithms and related algorithm IDs, a selected protection type indicator, or a validity or lifetime of the latest public key of the RAN.

The controller 1006 may manage input and output signals for the NE 1000. The controller 1006 may also manage peripherals not integrated into the NE 1000. In some implementations, the controller 1006 may util an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

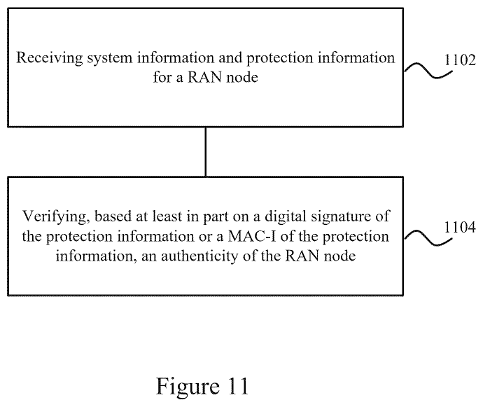

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include receiving system information and protection information for a RAN node. The operations of 1102 may be performed in accordance with examples as described herein. In some implementations, aspects of the operations of 1102 may be performed by a UE as described with reference to FIG. 8.

At 1104, the method may include verifying, based at least in part on a digital signature of the protection information or a MAC-I of the protection information, an authenticity of the RAN node. The operations of 1104 may be performed in accordance with examples as described herein. In some implementations, aspects of the operations of 1104 may be performed by a UE as described with reference to FIG. 8.

It should be noted that the method described herein describes a possible implementation, and that the operations and the steps may be rearranged or otherwise modified and that other implementations are possible.

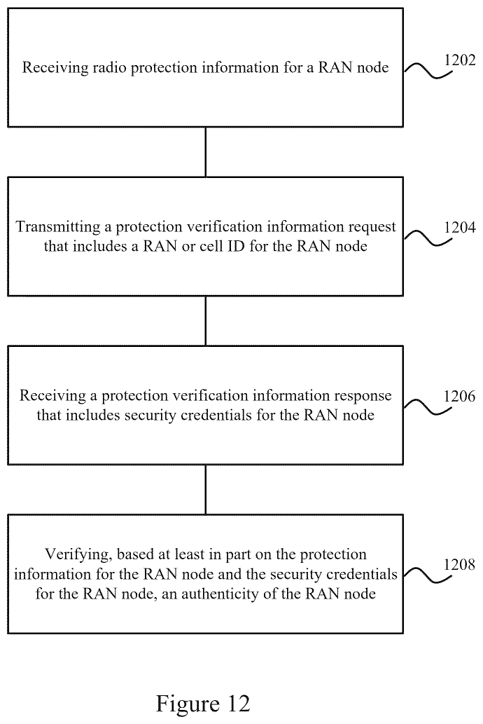

FIG. 12 illustrates a flowchart of a method in accordance with aspects of the present disclosure. The operations of the method may be implemented by a UE as described herein. In some implementations, the UE may execute a set of instructions to control the function elements of the UE to perform the described functions.

At 1202, the method may include receiving protection information for a RAN node. The operations of 1202 may be performed in accordance with examples as described herein. In some implementations, aspects of the operations of 1202 may be performed by a UE as described with reference to FIG. 8.

At 1204, the method may include transmitting a protection verification information request that includes a RAN or cell ID for the RAN node. The operations of 1204 may be performed in accordance with examples as described herein. In some implementations, aspects of the operations of 1204 may be performed by a UE as described with reference to FIG. 8.

At 1206, the method may include receiving a protection verification information response that includes security credentials for the RAN node. The operations of 1206 may be performed in accordance with examples as described herein. In some implementations, aspects of the operations of 1206 may be performed a UE as described with reference to FIG. 8.

At 1208, the method may include verifying, based at least in part on the protection information for the RAN node and the security credentials for the RAN node, an authenticity of the RAN node. The operations of 1208 may be performed in accordance with examples as described herein. In some implementations, aspects of the operations of 1208 may be performed a UE as described with reference to FIG. 8.

It should be noted that the method described herein describes a possible implementation, and that the operations and the steps may be rearranged or otherwise modified and that other implementations are possible.

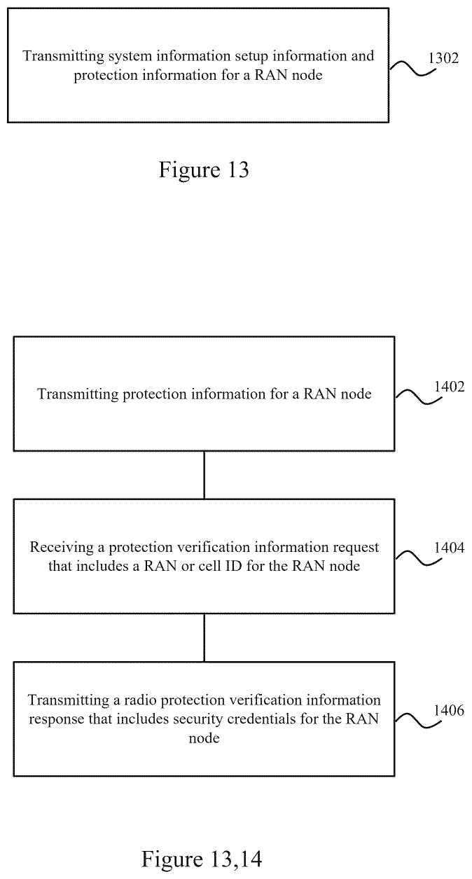

FIG. 13 illustrates a flowchart of a method in accordance with aspects of the present disclosure. The operations of the method may be implemented by an NE as described herein. In some implementations, the NE may execute a set of instructions to control the function elements of the NE to perform the described functions.

At 1302, the method may include transmitting system information setup information and protection information for a RAN node. The operations of 1302 may be performed in accordance with examples as described herein. In some implementations, aspects of the operations of 1302 may be performed by an NE as described with reference to FIG. 10.

FIG. 14 illustrates a flowchart of a method in accordance with aspects of the present disclosure. The operations of the method may be implemented by an NE as described herein. In some implementations, the NE may execute a set of instructions to control the function elements of the NE to perform the described functions.

At 1402, the method may include transmitting protection information for a RAN node. The operations of 1402 may be performed in accordance with examples as described herein. In some implementations, aspects of the operations of 1402 may be performed by an NE as described with reference to FIG. 10.

At 1404, the method may include receiving a protection verification information request that includes a RAN or cell ID for the RAN node. The operations of 1404 may be performed in accordance with examples as described herein. In some implementations, aspects of the operations of 1404 may be performed by an NE as described with reference to FIG. 10.

At 1406, the method may include transmitting a radio protection verification information response that includes security credentials for the RAN node. The operations of 1406 may be performed in accordance with examples as described herein. In some implementations, aspects of the operations of 1406 may be performed an NE as described with reference to FIG. 10.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive system information and protection information for a radio access network (RAN) node; and
verify, based at least in part on a digital signature of the protection information or a message authentication code for integrity (MAC-I) of the protection information, an authenticity of the RAN node.

2. The UE of claim 1, wherein the at least one processor is operable to cause the UE to receive a set of authorized RAN node identifiers (IDs), serving area and cell ID information, and RAN data protection or security information.

3. The UE of claim 1, wherein to receive the system information, the at least one processor is operable to cause the UE to receive a master information block (MIB), and wherein to verify the authenticity of the RAN node, the at least one processor is operable to cause the UE to verify the authenticity of the RAN node based at least in part on one or more of a set of authorized RAN node identifiers (IDs), a set of cell IDs, or the protection information.

4. The UE of claim 1, wherein to receive the system information, the at least one processor is operable to cause the UE to receive a system information block type 1 (SIB1), and wherein to verify the authenticity of the RAN node, the at least one processor is operable to cause the UE to verify the authenticity of the RAN node based at least in part on one or more of a set of authorized RAN node identifiers (IDs), a set of cell IDs, or the protection information.

5. The UE of claim 1, wherein the protection information comprises an identifier of a protection algorithm.

6. The UE of claim 5, wherein the at least one processor is further operable to cause the UE to receive information including an identifier (ID) associated with the RAN node, and a parameter, wherein the ID comprises one or more of a RAN node ID, a cell ID, or a public key ID, wherein the parameter indicates how recent or up-to-date the information is, wherein to receive the system information, the at least one processor is operable to cause the UE to receive a radio resource control (RRC) setup message, and wherein to verify the authenticity of the RAN node, the at least one processor is operable to cause the UE to verify the authenticity of the RAN node based at least in part on the public key ID and the protection algorithm.

7. The UE of claim 6, wherein the digital signature comprises a digital signature of one or more of: an information block, the RRC setup message, the protection information, the RAN node ID, the cell ID, the public key ID, or the parameter.

8. The UE of claim 1, wherein to receive the system information, the at least one processor is operable to cause the UE to receive a radio resource control (RRC) setup message.

9. A user equipment (UE) for wireless communication, comprising:
at least one memory; and
at least one processor coupled with the at least one memory and operable to cause the UE to:
receive protection information for a radio access network (RAN) node;
transmit a protection verification information request that includes a RAN or cell identifier (ID) for the RAN node;
receive a protection verification information response that includes security credentials for the RAN node;
verify, based at least in part on the protection information for the RAN node and the security credentials for the RAN node, an authenticity of the RAN node.

10. The UE of claim 9, wherein the protection information comprises an identifier of an information protection algorithm.

11. The UE of claim 9, wherein the security credentials for the RAN node comprise at least one of a latest public key of the RAN node, a latest valid certificate of the RAN node, a root certificate authority (CA) certificate of an issuer of the latest valid certificate of the RAN node, one or more selected protection algorithms and related algorithm identifiers (IDs), a selected protection type indicator, or a validity or lifetime of the latest public key of the RAN.

12. The UE of claim 9, wherein to verify the authenticity of the RAN node, the at least one processor is further operable to cause the UE to verify the authenticity of the RAN node based at least in part on a digital signature of the protection information or a message authentication code for integrity (MAC-I) of the protection information.

13. The UE of claim 9, wherein the at least one processor is operable to cause the UE to verify the authenticity of the RAN node based at least in part on one or more of a list of authorized RAN identifiers (IDs), cell IDs, or protection information.

14. The UE of claim 9, wherein to transmit the protection verification information request, the at least one processor is operable to cause the UE to transmit the protection verification request to a verification service, and wherein to receive the protection verification information response, the at least one processor is operable to cause the UE to receive the protection verification information response from the verification service.

15. A network equipment (NE) for wireless communication, comprising:
at least one memory; and
at least one processor coupled with the at least one memory and operable to cause the NE to:
transmit system information and protection information for a radio access network (RAN) node.

16. The NE of claim 15, wherein the NE is provisioned with an authorized RAN node identifier (ID), serving area and cell ID information, and RAN data protection or security information.

17. The NE of claim 15, wherein the protection information comprises an identifier of a protection algorithm.

18. The NE of claim 15, wherein the at least one processor is further operable to cause the NE to transmit information including a RAN or cell identifier (ID) for the RAN node, a public key identifier (ID) for the RAN node, and a parameter that indicates how recent or up-to-date the information is.

19. A network equipment (NE) for wireless communication, comprising:
at least one memory; and
at least one processor coupled with the at least one memory and operable to cause the NE to:
transmit protection information for a radio access network (RAN) node;
receive a protection verification information request that includes a RAN or cell identifier (ID) for the RAN node;
transmit a radio protection verification information response that includes security credentials for the RAN node.

20. The NE of claim 19, wherein the security credentials for the RAN node comprise at least one of a latest public key of the RAN node, a latest valid certificate of the RAN node, a root certificate authority (CA) certificate of an issuer of the latest valid certificate of the RAN node, one or more selected protection algorithms and related algorithm identifiers (IDs), a selected protection type indicator, or a validity or lifetime of the latest public key of the RAN.
